(19) United States
(12) Patent Application Publication
(10) Pub. No.: US 2025/0178830 A1
(43) Pub. Date: Jun. 5, 2025

(54) FLOATING ROOF TANK MONITORING APPARATUS AND METHODS

(71) Applicant: AXON4D CORP., Airdrie (CA)

(72) Inventors: Jared Johan FISK, Airdrie (CA); Christopher William JOHNSON, Royston (CA)

(21) Appl. No.: 18/845,267

(22) PCT Filed: Mar. 9, 2023
(86) PCT No.: PCT/CA2023/050309

§ 371 Date: Sep. 9, 2024

Related U.S. Application Data
(60) Provisional application No. 63/318,157, filed on Mar. 9, 2022.

(51) Int. Cl. B65D 90/51; B65D 88/42; G01F 23/14; G01M 3/32

(52) U.S. Cl. CPC B65D 90/51; B65D 88/42; G01F 23/14; G01M 3/3209; G01M 3/3272

(57) ABSTRACT

Apparatus and methods for monitoring the status of a floating roof. The floating-roof tank assembly has: an impermeable roof section, and a floating-roof seal configured to span between the impermeable roof section and components of a container. One or more deformable floats are attached to the roof section to provide buoyancy so that the roof floats on top of the liquid contained in the container. To monitor the status of the floating roof tank, it is provided with a fiber optic sensor array comprising one or more fiber optic sensors. A light source configured to transmit light to the fiber optic sensors and a receiver configured to detect light from each fiber optic cable after it has interacted with the fiber optic cable. Based on the received light, a controller configured to process the light received by the receiver to determine the status of the floating roof tank.

### FIELD OF THE INVENTION

The invention relates to measuring and monitoring a floating roof tank. In particular, the technology relates to measuring and monitoring the status of the tank using an array of fiber optic sensors.

### BACKGROUND

A floating roof tank is a storage tank commonly used to store large quantities of petroleum products such as crude oil or condensate. It typically comprises a cylindrical shell equipped with a roof that floats on the surface of the stored liquid. The roof rises and falls with the liquid level in the tank. This helps to eliminate tank breathing loss and to reduce the evaporative loss of the stored liquid.

There is typically a rim seal assembly between the tank shell and roof to reduce rim evaporation. The seals are somewhat flexible in nature to navigate the shell deformations and welds that are present on the shell.

Most countries require that floating roof tanks are periodically inspected. For example, in the U.S. External Floating Roof seals are mandated by the EPA (United States Environmental Protection Agency) to be measured and inspected on an annual basis for damage and gaps to the shell while the tank is In-Service. This task generally requires people to wear clean breathing apparatus and a very comprehensive safety watch and rescue plan. Obtaining the data to ensure emissions are stopped and the environment is protected is important.

Safety certified personnel physically must enter confined storage tank spaces to conduct a Visual Inspection. Most often, this is done after the tank is decommissioned for compliance inspections. In the event of failure, this will be identified during inspection. Then, for compliance of floating roof seals, a necessary repair(s) will need to be performed within time periods allotted by the Standards of the jurisdiction. This can lead to the tank being out of commission until a repair can be made, which may take considerable time.

### SUMMARY

According to a first aspect of the present disclosure, there is provided a floating-roof tank assembly comprising:
an impermeable roof section;
a floating-roof seal configured to span between the impermeable roof section and walls of a container;
one or more deformable floats attached to the roof section;
a fiber optic sensor array comprising one or more fiber optic sensors;
a light source configured to transmit light to the one or more fiber optic sensors;
a receiver configured to detect light from each fiber optic sensor; and
a controller configured to process the light received by the receiver to determine the status of the floating roof tank.

One or more of the fiber optic sensors may be attached to the floating roof tank assembly. One or more of the fiber optic sensors may be attached to the container. The fiber optic sensors may be configured to monitor parameters to the floating roof tank assembly (e.g., position, tilt, orientation, presence of liquids at certain positions).

A fiber optic sensor may comprise a fiber optic cable and may be configured to monitor a parameter by detecting changes in the light passing through the fiber optic cable caused by that parameter. For example, a deformation sensor may measure deformation in a Bragg grating within the fiber optic cable by monitoring how light passing through the fibre optic cable changes when the spatial frequency of the Bragg grating changes as a result of the deformation. Other fiber optic sensors may measure a parameter indirectly. For example, a liquid sensor may have a Bragg grating in a portion of the fibre optic cable connected to an expandable material that changes size and/or shape in the presence of liquid (e.g., hydromorphic polymers for water). The system directly measures the deformation of the Bragg grating and determines the presence of liquid, because the expandable material is the cause of the deformation.

A sensor may be configured to measure a parameter at a particular point (e.g., a tilt sensor may be configured to determine the tilt at the position of the tilt sensor). A sensor may be configured to measure a parameter along a line (e.g., a fibre optic deformation sensor may determine the deformation along the length of a section of fibre optic cable). A sensor may be configured to measure a parameter in an area and/or volume (e.g. a lidar sensor may monitor an area of the roof within a volume of space).

A floating-roof seal may comprise one or more of the following components:
a shoe assembly containing a shoe plate which contacts the tank shell, a hanger which attaches to the roof section rim, a mechanical mechanism and compression bar that helps maintain a bias between the tank shell and roof section rim, and possibly other associated hardware;
a vapor barrier fabric that prevents emission of volatile organic compounds (VOC) and other emissions (the vapor barrier may be supported by a fabric support strap); and
a compression plate that maintains bias between the lower half of the shoe plate and the tank shell.

The hangar may comprise a rigid bar be connected to, and hang substantially below, the roof section and be connected to the mechanical mechanism which, in turn, is connected to the shoe plate.

A float may comprise a sealed liquid-impermeable vessel which contains a gas. When not pressurized, the walls of the vessel may be flexible (e.g., formed from rubber) or relatively rigid (e.g., formed from a metal).

A float may comprise an enclosure that is non-pressurized and vented to atmosphere (e.g., annular steel pontoon).

The one or more fiber optic sensors may comprise a float pressure sensor, the float pressure sensor comprising a fibre optic cable portion configured to detect strain in one or more of the deformable floats, and wherein the controller is configured to determine a pressure of the deformable float based on the detected strain.

The float pressure sensor may comprise a deformable diaphragm which is connected to a said float such that one side of the diaphragm is in contact with the gas inside the float, and an opposite side of the diaphragm is in contact with the atmosphere. The diaphragm may be considered to a deformable component of float wall. The float pressure sensor may comprise a screw thread to allow the float pressure sensor to be screwed into a corresponding hole in the float. The float pressure sensor may comprise a rigid tubular housing in the form of a tube wherein the diaphragm is positioned to span across the interior of the tube preventing fluid flow from one end of the tube to the other. The rigid tubular housing may help prevent deformation of the float to which the float pressure sensor is attached from affecting the strain measurement on the diaphragm. That is, the rigid housing may help ensure that the diaphragm strain is due to pressure changes only, and not as a result of other deformations in the float. The float may be deformable such that as the sealed float is submerged more deeply in a liquid, the pressure inside the float increases due to the float being compressed.

The controller may be configured to monitor the pressure of the deformable float over time to identify leaks in the deformable float.

The controller may be configured to identify different leak types based on the rate of change of pressure monitored over time. The controller may be configured to identify the size of the leak based on the rate of change of pressure monitored over time.

The controller may be configured to identify whether the leak is in contact with a liquid or a gas based on characteristic frequency components within the determined pressure readings over a period of time. E.g., a leak below the liquid level may generate a periodic vibration due to bubbles being formed.

The controller may be configured to correlate the monitored pressure of multiple deformable floats.

The controller may be configured to provide a notification (e.g., an alert) if the monitored pressures are outside a predetermined range.

The controller may be configured to calculate a time to the monitored pressure being outside a predetermined range based on fitting the monitored pressure as a function of time.

The strain sensor may be mounted outside the vessel by a mechanical strap or directly to the vessel.

The one or more fiber optic sensors may comprise an array of multiple sensors around the exterior or circumference of the float to measure changes in shape.

The one or more fiber optic sensors may comprise a float liquid detection sensor positioned inside a float (e.g., annular steel pontoon) to detect the presence of product or water.

Liquid sensors may be configured to detect the presence of water and/or product stored within the tank (e.g., hydrocarbon).

The one or more fiber optic sensors may comprise a float vapor detection sensor positioned inside an unpressurized float (e.g., annular steel pontoon) to detect the presence of fuel vapors, V.O.C.'s (volatile organic compounds), or evaporation of other solvents.

The one or more fiber optic sensors may comprise a roof liquid detection sensor positioned on an upper surface of the floating roof to detect ponding.

The one or more fiber optic sensors may comprise one or more FMCW (frequency modulated continuous wave) lidar units positioned around the tank shell (or container) and facing toward the floating roof to detect a multitude of conditions (e.g., position, velocity, frequency of vibration of various components).

Lidar is an acronym of “light detection and ranging” or “laser imaging, detection, and ranging”. FMCW lidar may modulate the phase and/or frequency of the light source (e.g., a single-mode laser). A phase shift may be detected by mixing the reflected chirp (from the environment being monitored) with a reference version of the chirp. Using different chirps allow different parameters to be determined (e.g., range and relative velocity between the source and the point being observed).

Lidar may determine the polarization of light. When light shines at a certain angle, it is possible for the reflected light to become partially or completely polarized (polarization by reflection). The angle at which complete polarization occurs is the polarizing angle or the Brewster angle. The lidar may be set up to allow the system to determine the nature of the material (e.g., on the surface of the tank) using the polarization of the light reflecting off the surface. E.g., the system may be able to distinguish between liquid water and product (e.g., hydrocarbon) based on the degree of polarization of light reflected from the surface (e.g., at different positions on the liquid surface).

The lidar units may be configured to monitor other major visible components such as the inner shell and the ceiling of an IFR (internal floating roof) roof.

The lidar units may comprise one or more roof lidar units configured to monitor the top surface of the floating roof. The lidar units may comprise one or more container lidar units configured to monitor the interior and/or exterior surfaces of the container or shell. The lidar units may comprise one or more ceiling lidar units configured to monitor the interior surface of a fixed roof (e.g., in an internal floating roof tank).

The one or more fiber optic sensors may comprise a liquid level sensor. The one or more fiber optic sensors may comprise a liquid level pressure sensor positioned at the bottom of the tank. The liquid level pressure sensor may comprise a gas-filled sealed deformable vessel and a strain sensor configured to determine the deformation of the sealed deformable vessel, and wherein the controller is configured to determine the liquid level based on the pressure determined by the liquid level pressure sensor.

The one or more fiber optic sensors may comprise a fibre optic sensor (e.g., a Fiber Bragg Grating sensor or FBG) attached to a fabric support strap to measure deflection, compression, or tension of the strap and wherein the controller is configured to determine the rim space displacement based on the compression and tension determined by the sensor. This rim space displacement closely follows the tension of the vapor barrier fabric and can help determine the integrity of the fabric. The controller may also be configured to determine the vibration of the shoe plate moving against the tank shell. The raw data collected from the sensor(s) and read by the controller can be interpreted to arrive at both the vibratory and rim space values. The vibration data helps determine the degree of contact with the tank shell. When vibration and rim space displacement information is considered together, and accurate picture may be formed to determine the integrity of the floating roof seal.

The one or more fiber optic sensors may comprise one or more tilt sensors mounted on the impermeable roof section and configured to detect tilt of the impermeable roof section.

The fibre optic sensor array may comprise multiple tilt sensors mounted at different positions on the impermeable roof section, and wherein the controller is configured to determine deformation of the impermeable roof section based on the different tilts of the roof measured at the different positions.

The one or more fiber optic sensors may comprise a displacement sensor connected between the roof section and a shoe of the floating-roof seal (e.g., mounted on a linkage mechanism), the displacement sensor being configured to determine the movement of the floating-roof seal with respect to the impermeable roof section.

The displacement sensor may comprise a strain sensor attached to a flexible component configured to span between the impermeable roof section and the shoe. The flexible component may or may not be a resilient component. The resilient component may comprise a sheet of metal. The flexible component may be attached to the roof section and be configured to slide along the inner surface of the shoe as the shoe is displaced with respect to the roof section. The system may comprise one or more upper displacement sensors configured to engage with the shoe towards the top of the shoe, and one or more lower displacement sensors configured to engage with the shoe towards the bottom of the shoe. The combination of these sensors may help determine the tilt of the shoe with respect to the impermeable roof section.

The one or more fiber optic sensors may comprise a sensor (e.g., FBG) attached to a rigid component to sense movement (e.g., an articulated arm, mechanism, or hydraulic or pneumatic ram), or may be embedded in its own mechanism to follow the motion of said rigid components. The controller may be configured to determine the vibration of the shoe plate moving against the tank shell.

The one or more fiber optic sensors may comprise a sensor (e.g., FBG) attached to a mechanical mechanism or component (e.g., a spring, plate, bar, or strap) to measure deflection, compression, or tension of the mechanism or component and wherein the controller is configured to determine the rim space displacement based on the compression and tension determined by the sensor. The controller may be configured to determine the vibration of the shoe plate moving against the tank shell. The raw data collected from the sensor(s) and read by the controller can be interpreted to arrive at both the vibratory and rim space values. The vibration data helps determine the degree of contact with the tank shell. When vibration and rim space displacement information is considered together, and accurate picture may be formed to determine the integrity of the floating roof seal.

The one or more fiber optic sensors may comprise a sensor attached to a wiper (tank shell contact point) of the seal assembly and may be attached to metallic components of the wiper to determine the degree of wiper-to-shell contact through vibration. The controller may be configured to determine the vibration of the wiper moving against the tank shell.

The one or more fiber optic sensors may comprise a configuration of sensors attached to a wiper seal (e.g., a resilient sheet of material spanning between the roof section and the tank shell contact point) of the seal assembly and may be attached to metallic components of a wiper seal assembly to determine the 1, 2, or 3 dimensional data of the wiper at that point. A configuration containing only 1 sensor provides only strain data, a configuration containing 2 sensors provides 2-dimensional data, and a configuration containing 3 or more sensors provides 3-dimensional data. The wiper seal may form at least part of the floating-roof seal.

The controller may be configured to determine the degree of contact between the floating-roof seal and the container based on monitoring vibrations detected by the displacement sensor, the sensor attached to the ridged component(s), the sensor attached to the mechanical mechanisms/components, the sensor attached to the vapor barrier strap, or the sensor attached to the wiper.

The controller may be configured to determine the status of motorized or mechanical equipment such as an agitator used to stir up the contents of a tank. The agitator(s) would produce a vibrational signature (e.g., in the shell or the roof) that could be monitored using one or more fiber optic sensors. For many tanks, the agitator is always running if there is liquid in the tank. An agitator that stops running, or an agitator with a failing bearing will produce a varied harmonic. The controller may be configured to generate an alert in response to the agitator stopping or producing a different frequency spectrum from the normal frequency spectrum. The controller may be configured to only initiate alerts relating to the agitator when the system determines that there is fluid in the tank (e.g., based on a determined liquid level).

The controller may be configured to correlate multiple fiber optic sensors to determine the orientation of the impermeable roof section.

The one or more fiber optic sensors may comprise a tilt sensor mounted on a tilting structure connected between the container and the roof and configured to tilt as the height of the roof changes, and wherein the controller is configured to determine the height of the roof based on the tilt of the tilting structure.

The floating-roof tank assembly may comprise one or more enclosed cavities, each enclosed cavity being isolated from the interior of the container; and wherein the one or more fiber optic sensors comprises a fiber optic chemical sensor configured to identify a change in the chemical composition of the contents of a said cavity.

A chemical sensor may be a sensor configured to detect a specific chemical (e.g. water) and/or a class of chemical compounds (e.g., hydrocarbons). A chemical sensor may comprise a liquid sensor and/or a vapor sensor configured to detect materials based on their physical state. A vapor sensor may detect the presence of gases.

The floating-roof tank assembly may comprise one or more enclosed cavities, each enclosed cavity being isolated from the interior of the container; and wherein the one or more fiber optic sensors comprises a fiber optic liquid detection sensor configured to identify the presence of liquid inside said cavity.

A said enclosed cavity may include one or more of: a pontoon cavity, a hexagon membrane cavity; an annular cavity; a double pan cavity; a rim cavity; a seal cavity; and a vapor barrier cavity.

A plurality of the array of fibre optic sensors may be connected in series, parallel, star, or combinations thereof.

The controller may be configured to monitor at least one of the fiber optic sensors and record two or more of the following metrics: a state metric corresponding to a value of a measured parameter at a point in time, a rate metric corresponding to the rate at which the measured parameter is changing over a period of time, and a frequency metric corresponding to frequency components of the measured parameter over a period of time. The frequency metric may be determined based on a Fourier transform of the measured parameter or state metric over a period of time.

This technology relates to the fiber optic sensing and monitoring of status for storage tank floating roofs. The status may include one or more of the following: pontoon status, integrity, pressure (psi), presence of hydrocarbon gases or liquids. The status may be monitored over time. The system may be configured to diagnose failure mechanisms based on the status.

The status of the tank may include a determination of the relative position and orientation of components of the tank (e.g., the height of the roof section within the tank shell, the tilt of the roof section, the tilt of the rolling ladder, the distance of shoes, plates, bars, or fabric from the roof section, the position of the floating roof relative to the tank shell as determined by the array of displacement sensors). The status of the tank may include the shape of deformable components (e.g., the shape of the roof section, the shape of the pontoon, the shape of one or more deformable seals).

The status of the tank may include whether any components of the tank are broken, are faulty or have been damaged (e.g., if a float has deflated, if a rolling ladder has been damaged, if a biasing member has broken or a mechanical linkage has seized, if an agitator stops working). The status of a tank may include thresholds of mechanical limits that if exceeded, may indicate a mechanical failure of tank components (e.g., a displacement sensor sensing rim space that has exceeded the lower limits of physical displacement may indicate a mechanical shoe that is damaged or missing). The status of a tank may include the presence of authorized or unauthorized personnel.

The status of the tank may include a determination of the quantity of liquid stored in the tank. The status of a tank may include the distributed temperature. The status of a tank may include the presence of liquid in an area that should otherwise remain dry.

This technology may be applied to a floating Roof Types listed within API 575, 653, 650 Annex H, not limited to, Metallic Pan, Rolled Pan, Metallic Open-Top Bulk-Head, Metallic Pontoon, Pan Type Floating-roof Tank, Annular-pontoon Floating-roof Tank, Double-deck Floating-roof Tank, Hexagon/Honeycomb membrane style, Full-Contact, Cable Suspended or Leg Supported.

The strain sensor used in conjunction with a deformable surface to form a pressure sensor may be a Technica™ T210 or T211 strain sensor. A simpler FBG, such as a Technica™ T20, may be used in place of a strain sensor to measure a deformable surface.

In accordance with another aspect, there is provided an apparatus for measuring the deformation in a floating-roof seal assembly comprising:
a deformable floating-roof seal assembly configured to span between a rigid section of a floating roof and components (e.g. wall) of a container;
a fiber optic cable assembly comprising one or more fiber optic cables, each fiber optic cable being attached along its length to the floating-roof seal assembly such that each fiber optic cable is deformed when the floating-roof seal assembly is deformed;
a light source configured to transmit light along each fiber optic cable; and
a receiver configured to detect light from each fiber optic cable after it has interacted with the fiber optic cable.

The fiber optic cable assembly may comprise multiple fiber optic cables arranged in parallel about a common fiber optic cable assembly axis. The receiver may be configured to determine the deformation using differences between the responses of the multiple fiber optic cables. The fiber optic cable assembly may comprise at least three fiber optic cables arranged such that they do not all lie in the same plane. This configuration would allow curvature to measured in two different directions at a particular point along the fiber optic cable assembly axis. The fiber optic cable may contain “Fiber Bragg Gratings” of similar or varied types.

A storage tank may comprise a container and a floating roof. The container may comprise a shell (e.g., a wall configured to retain liquid), a floor and one or more internal columns. The floating roof may comprise a relatively rigid roof section and one or more deformable seal assemblies. In other embodiments, the roof section may also be flexible. The rigid roof section may comprise a float, membrane, or pontoon for allowing the roof to float on the liquid stored within the container. The container may comprise a fixed roof above the floating roof.

The deformable floating-roof seal assembly may comprise components which are made of a deformable or resilient material. The deformable floating-roof seal assembly may comprise a mechanical mechanism comprising multiple rigid components which are connected together to allow relative movement between the rigid components to facilitate deformation (e.g., an articulated arm, or hydraulic or pneumatic ram). The mechanical mechanism may comprise biasing members such as one or more springs, plates, or bars that exert compression forces on a shoe plate and/or tank shell. (e.g., to bias a shoe seal from the roof section). The mechanism may comprise biasing members such as a vapor barrier fabric support strap.

The deformable floating-roof seal assembly may be configured to reduce rim evaporation. The deformable floating-roof seal assembly may form a substantially airtight seal between the rigid section of the roof and the container.

The floating-roof seal assembly may comprise a skirt of resilient material. The skirt may be of unitary construction. The skirt may comprise multiple connected or overlapping sections.

The floating-roof seal assembly may comprise multiple skirts of resilient material.

The floating-roof seal assembly may be configured to span a gap between a rigid section of the floating roof and walls of a tank shell.

The floating-roof seal assembly may be configured to span a gap between a rigid section of the floating roof and internal columns within a tank shell.

The floating roof may comprise:
the impermeable roof section;
the floating-roof seal configured to span between the impermeable roof section and one or more walls of a container; and
the one or more floats attached to the roof section.

A sensor assembly may comprise:
a fiber optic sensor array comprising one or more fiber optic sensors;
a light source configured to transmit light to the one or more fiber optic sensors;
a receiver configured to detect light from each fiber optic sensor; and
a controller configured to process the light received by the receiver to determine the status of the floating roof tank.

A sensor assembly may comprise one or more lidar units.

The fiber optic cable may extend around at least ¾ of the diameter of the floating roof. The fiber optic cable may extend around at least ½ of the diameter of the floating roof. There may be more than one fiber optic cables around the floating roof. One or more closest to the shell and one or more closest to the floating roof rim. These fiber optic cables may reference each other for position. Each fiber optic cable may serve multiple functions (i.e., vibration/displacement, vibration/shape-sensing, vibration/temperature).

The apparatus may comprise a wireless transceiver for transmitting data from the apparatus to a remote computer. Wireless transmission may be transmitted using radio waves (e.g., from range from around 20 kHz to around 300 GHz). Wireless transmission may include LTE, WiFi, or LoRaWAN.

The receiver may be configured to detect interactions with the fiber optic cable in one or more of the following modes: Rayleigh, Brillouin, Raman and time-of-flight.

The apparatus may be configured to provide an alert when the deformation of the shell meets one or more predetermined criteria. These criteria may be based on, for example, API Standard 650 (“Welded Tanks for Oil Storage”, Effective date Sep. 1, 2020) These criteria may include one or more of the following:
Deviation beyond a predetermined roundness value (e.g. API Standard 650 Section 7.5.3 Roundness);
Deviation beyond a predetermined plumbness value (e.g. 1/200 th of shell height or API Standard 650 Section 7.5.2 Plumbness);
Local deviations beyond a predetermined level;
Deviations (peaking) at vertical weld joints shall not exceed a predetermined value (e.g., 13 mm or ½ in).
Deviations (banding) at horizontal weld joints shall not exceed a predetermined value (e.g., 13 mm or ½ in).
Flat spots measured in the vertical plane shall not exceed a predetermined plate flatness value and/or predetermined waviness value.

The apparatus may be configured to provide an alert when the status of the floating roof tank assembly meets one or more predetermined criteria. These may include:
Detecting that the tilt of the roof exceeds a predetermined angle (e.g., 5°)
Detecting an out-of-range vertical roof position (e.g., low, low-low, high, high-high. Low & high status require immediate action be taken to correct level whereas low-low & high-high require an automatic or manual shutdown of the system).
Detecting rolling ladder anomalies.
Detecting low or high temperatures in one or more sensors.
Detecting temperatures that indicate fire conditions, or imminent fire conditions.
Detecting that one or more of the pontoons has lost pressure.
Detecting that one or more of the pontoons has changed shape (e.g. becoming more oval than round, bowing, or twisting)
Detecting that the roof portion has deformed more than a predetermined threshold (e.g., if the difference in tilt at different positions exceeds a predetermined threshold, wind rippling of the deck sheathing has occurred, the roofs legs have ‘bottomed’ out and made contact with the floor of the tank).
Detecting that the visible portion of the inner tank shell & the entire portion of the outer tank shell has deformed more than a predetermined threshold using FMCW Lidar detection.
Detecting that a significantly changed condition has occurred to a component vital to correct tank operation using FMCW Lidar detection (e.g., a guide pole or deck leg has deformed).
Detecting that a significantly changed condition has occurred to the entirety of the tank such as foundational shifting or settlement.
Detecting that chemicals (e.g., hydrocarbons) or liquids (e.g., water and/or tank contents) have entered into cavities which are designed to be isolated from the contents of the tank.
Detecting vapors in cavities which are designed to be isolated from the contents of the tank.
Detecting that excessive water has accumulated on the floating roof.
Detecting whether a floating roof sump is draining said water adequately.
Detecting that a vapor barrier fabric is torn.
Detecting a ‘rollover’ condition, or imminent rollover condition, of a secondary seal.
Detecting that part of a floating roof seal (spring, plate, bar, strap) has exceeded it's allowable strain/deformation.
Detecting the degree of contact between a shoe plate and the tank shell
Detecting the degree of contact between a wiper and the tank shell.
Detecting abnormal behaviors between tank components such as a floating roof failing to move during discharge/receipt of product.
Detecting the presence of liquid leaked through the flooring or into the foundation drains.
Detecting the presence of unauthorized personnel.
Detecting abnormal environmental activity (e.g., seismic).

The apparatus may be configured to provide an alert when the forces applied to the tank meets one or more predetermined criteria. These criteria may include one or more of the following:
Wind forces exceeding a predetermined wind-force value (which may be related to the overturning stability of the tank—see API Standard 650 Section 5.11); and
Seismic forces exceeding a predetermined seismic value.
Extreme temperature variations (e.g., temperatures or temperature changes exceeding a predetermined threshold).
Foundational forces and imbalances as a result of seismic activity, ground composition, or ground water porous levels.

The apparatus may be configured to provide an alert when the sealing assembly meets one or more predetermined criteria. These criteria may include one or more of the following:
The average width of the open seal gap between the seal and the shell, determined by averaging the minimum gap width and the maximum gap width, exceeding a predetermined average-gap value (or exceeding a maximum gap width of 8″); and
The ratio of open seal gap area (the product of the open seal gap length and average open seal gap width) to vessel diameter for a seal exceeding a predetermined ratio value.

For example, for open seal gaps between the primary seal and the shell, the total accumulated gap area shall not exceed 212 cubic centimeters per meter of nominal diameter (10 square inches per foot of nominal diameter). Maximum open gap allowed may be 3.81 cm (1.5 inches). For open seal gaps between the secondary seal and the shell, the total accumulated gap area shall not exceed 21.2 cubic cm per meter of nominal diameter (1 cubic inches per foot of nominal diameter). Maximum open gap allowed may be 1.27 cm (0.5 inches).

It will be appreciated that the predetermined values may be absolute or relative to the dimensions of the tank.

The apparatus may be configured to continuously monitor deformation.

The light receiver may comprise a photodetector. The light receiver may comprise a time-resolved photodetector. The photodetector may comprise GaAs and/or InGaAs. The wavelength range of sensitivity of the light receiver may be between 500-1630 nm (most likely 1550 nm). The bandwidth of the light receiver may be between DC to 26 GHz.

The light receiver may be an optical sensing interrogator such as a Micron Optics™ sm125-500, 130-700 or si155 Standard; HBM™ FS22 or FS42; a Smart Fibers™ SmartScope FBG or SmartScan™ FBG; a FAZT 14G; an Optilab™ FSI-RM-18 or a BaySpec™ WaveCapture™; or an Ibsen™ I-MON.

The light receiver may be integrated with an industrial computer for the purpose of “edge computing” or “pre-processing” data.

There may be one or more types of light receivers within the system which may be positioned at different locations (e.g., Installed on the floating roof vs. installed on the tank shell exterior). The light receiver that interrogates sensors integrated into the fiber optic line may differ from the light receiver that interprets FMCW lidar data.

The refractive index of fiber optic cable may be between 1.4 and 1.5. This corresponds to light speeds within the fiber optic cable, s_{fo}, of between 200 and 215 m/μs. To have meter resolution in a backscattering configuration, the photodetector would need to be able to distinguish signals received around 9-10 ns apart (2×1m/s_{fo}). Apparatus with higher temporal resolution (e.g., in the picosecond range) would have a higher spatial resolution. The operating wavelength of the fiber optic cable may be between 1460-1650 nm. The operating wavelength of the fiber optic cable may be between in the IR range-between 780 nm and 3 μm (e.g., 980, 1060, 1310 nm, 1550 nm). IR may include IR-A (780 nm-1.4 μm) or IR-B (1.4-3 μm) ranges.

The apparatus may be battery powered, be connectable to the mains and/or comprise a renewable power source (e.g., a solar panel and/or a wind turbine).

The apparatus may be configured to monitor for harmonic deformations. Harmonic deformations or vibrations may be indicative of forces being applied to the tank (e.g., by wind or seismic events). The frequency of the harmonic deformations may be in the range of between 20 to 0.01 hertz (e.g., 1 to 0.1 hertz).

The system may be configured to scan every 500 ms. The system may be configured to adjust the sampling rate based on the deformation. For example, the system may be configured to record the data continuously when deformation is taking place, and to reduce the sample rate if no deformation changes are detected (e.g., down to a minimum sampling rate). The system may be configured to adjust the sampling rate based on variations of one or more sensors (e.g., the rate of data change collected from a sensor(s) has increased, therefore increase sampling rate of that or corresponding sensor(s) until condition returns to normal).

The system may be configured to identify characteristic frequencies depending on the position of the roof within the tank. The vibrational frequency may depend on the level of the liquid in the tank and/or the thickness of the shell (typically the lower shell courses are thicker and more rigid and upper course are thinner and more flexible).

A deformable component of the seal-assembly to which the fiber optic cable may be attached may comprise one or more of: a single wiper seal; a double wiper seal; a foam block; a foam-block envelope; a shoe plate, a shoe-plate arm; a shoe-plate spring; a compression plate; a compression bar; a floating roof rim hanger; vapor barrier fabric; a vapor barrier fabric support strap; a controllable polymer seal; a self-adjusting and/or swellable polymer seal; and a continuous seal.

The apparatus may be configured to perform multi-faceted distributed sensing such as Distributed Fiber Sensing (DFS) and Distributed Chemical Sensing (DCS), Distributed Temperature Sensing (DTS), Distributed Vibration Sensing (DVS), etc.

The apparatus may be configured to sense conditions through the cladding of the fiber optic cable in addition to the dedicated sensors. Much like advancements have been made in detecting vessels, earthquakes, and wildlife activity using fiber optic data transmission cables lying on the ocean floor, a system of fiber optic cables attached to an above ground storage tank may act as a secondary sensing system for certain metrics.

Software/firmware may be configured to take the received light from the fiber optic cable to detect vibration, shape, status change, rim space variables, the structural shape of the shell and/or the shell settlement. The apparatus would be initialized with the original shape (e.g. determined using LIDAR, photogrammetry, or wavelength data from calibrated positions of sensor components). From that point a running average of data may be kept. The apparatus may be configured to determine deviations from the initial state (e.g. an absolute change in shape) and from the running average (e.g. to detect accelerating deformations).

Additional sensors may be added in series or parallel to the existing fiber optic arrangement to detect chemical signatures and vibration.

The fiber optic cable assembly may be a multicore cable (e.g. the iXblue™ Multicore Fiber IXF-MC-7-SM-1550). For example, the multicore cable may comprise 7 cores in a hexagon & center configuration. Using multicore cable may allow the deformation of the sealing assembly to be more accurately determined because there would be multiple data streams for each position on the sealing assembly, and these data streams would be constrained and related to each other by virtue of the configuration of each core within the multicore cable.

The fiber optic cable assembly may comprise conventional fiber optic cable whereby the guiding of light occurs within a core of RI (refractive index) higher than RI of the surrounding material (cladding). The fiber optic cable assembly may also include “Microstructured Optical Fibers” (MOF) or “Photonic Crystal Fibers” (PCF) whereby the guiding of light is obtained through the presence of air holes in the area surrounding the core or within a hollow core itself.

The fiber optic cable assembly may consist of various types of fiber throughout the system. For example, a fiber suited for tighter bend radius' may be required when transitioning from the fixed shell to the floating roof, or a fiber suited for increased vibrational sensitivity may be required for the floating roof wiper assembly.

The fiber optic assembly may include a combination of multi-core, single-core, MOF, PCF, armored, breakout or any specialized cable that the application requires.

Variations in the fiber optic assembly, the laser, or the medium may lend itself to non-linear optical processes. Examples of variations may include altering the core of the fiber optic cable, the intensity of the laser, or attaching an additional cladding, coating, or material to the fiber optic assembly. Examples of non-linear optical processes may include frequency-mixing, Kerr effect, cross-phase modulation, four-wave mixing, cross-polarized wave generation, modulational instability, Raman amplification, optical phase conjugation, stimulated Brillouin scattering, multi-photon absorption, photoionisation, or chaos in optical systems. Other related processes, whereby the medium is affected by other causes, may include Pockels effects, acousto-optics, and Raman scattering. Through proper analysis of these non-linear optical processes, it may be possible detect conditions not otherwise detectable such as corrosion, color, liquid/material identification, magnetism, electrical charge, micro-fracturing, etc.

The light source may be a laser (e.g., a laser diode, a fiber laser etc.). The light source may be configured to emit light in the visible (400 nm-700 nm wavelength) and/or IR (700 nm-3 μm wavelength) range.

The controller may comprise a processor and memory. The memory may store computer program code. The processor may comprise, for example, a central processing unit, a microprocessor, an application-specific integrated circuit or ASIC or a multicore processor. The memory may comprise, for example, flash memory, a hard-drive, volatile memory. The computer program may be stored on a non-transitory medium such as a CD. The computer program may be configured, when run on a computer, to implement methods and processes disclosed herein. Memory and processing of sensor data may be divided between on-site, edge, and cloud computing.

The controller may be positioned on the exterior of the tank, away from the floating roof. This may improve the safety of the assembly by separating electronic components from the contents of the tank (e.g., which may be flammable).

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a cut-away perspective view of a floating-roof tank.

FIG. 1b is a cross-section view of the sealing mechanism of the embodiment of FIG. 1a.

FIG. 1c is a schematic of the central controller of the embodiment of FIG. 1a.

FIGS. 2a and b are alternative fiber optic cable networks which can be used to connect a set of fiber optic sensors to a central controller.

FIG. 2c is a schematic of a paired set of Bragg grating fiber optic cables used to measure strain.

FIG. 2d is a graph of how the frequency of light reflected from the set of Bragg gratings of FIG. 2c changed as one of the fiber optic cables is stretched and the other is compressed.

FIG. 3a is a side view of a pressure sensor mounted to a pontoon float.

FIG. 3b is a cross section view of another pressure sensor.

FIG. 4 is a cross section view of a tilt sensor.

FIG. 5 is a perspective view of a portion of the sealing mechanism with multiple shoes.

FIG. 6 is a cross-section view of a part of a sealing mechanism.

FIGS. 7a and 7b are side views of a mechanism for scaling tilt for a tilt sensor at different inclinations.

FIG. 8 is a cut-away perspective view of a floating-roof tank.

### DETAILED DESCRIPTION

### Introduction

As described above, typically, floating roof tanks are required to be inspected every year at a minimum. In the U.S., if they are not compliant, the EPA requires the owners to repair the tank to bring the tank back into compliance. The EPA generally gives only 45 days for the repair to be complete before fines are issued. The continuous monitoring of the seals may allow tanks to be tracked and operators notified of potential problems in advance to allow them to have more time to meet the regulatory requirements.

In person inspection depend on inspection time intervals, have high costs, put inspectors in potentially dangerous situations, only capture a relatively small amount of data, do not turn around data fast enough to the clients and are not integrated enough to allow the owner, engineer, inspector or data collector to be fully confident in the status of the tanks.

When the status of a tank is neglected or unknown, there is increased risk of accidents or catastrophic failure. In Pouyakian, M. et al. (Reference 1—see Reference section below for more details), the authors describe summarise the results of several earlier studies of accidents relating to floating roof tanks. They report that, in a study by Taveau in 2011, 206 accidents related to floating roof tanks were investigated, of which 145 were fire and 61 were explosion. According to another reported earlier study by Kletz et al., three main causes of accidents in these tanks are lightning (32%), maintenance operations (13%), and operational errors (12%). Other causes include equipment failure (8%), sabotage (8%), cracking and rupture (7%), leakage and rupture of pipe (6%), static electricity (5%), open flames (4%), natural disasters (3%) and volatile reactions (2%).

On their website, Enbridge reports (Reference 2) that statistics suggest that one in 149 tanks will have a $2-million-plus incident in a year. Sinking roofs result in substantial repair costs in the range of 1 to 2 million dollars, plus resultant loss of product.

These incidents may result from annular pontoons (or floats) filling with rainwater or liquid tank product such as crude oil. This filling of liquid compromises the buoyancy of the floating roof which can lead to sinking, capsizing, damage to the tank wall, fire from the vapors, or the release of stored product into the environment. Liquid can enter the annular pontoon through damaged/corroded sheathing or through an open access hatch. Floating roofs have been known to sink or capsize due to compromised buoyancy and other variables such as seismic activity, hurricane winds, rain & snow loading, drainage issues, shell deformations, etc. Early detection of liquid within annular pontoons and other factors such as roof ponding, snow loading, and shell deformations are vital to the prevention of catastrophic floating roof events.

If annular pontoons fill with products such as crude oil, there is also an increased risk of fire. The annular pontoons are unpressurized and vented to atmosphere. A lightning strike could ignite the fuel vapors and the liquid contents of the pontoon. The foam dam is designed to extinguish fires around the rim space, not the pontoons, thus there is typically no fire protection for the rest of the floating roof. Since lightning strikes are the leading cause of tank fires, fuel filled pontoons absent of fire protection cannot be overlooked.

A pontoon that contains a product such as crude oil has likely been perforated through damage or corrosion. This perforation in the sheathing not only allows tanks contents to enter the pontoon but allows any water that the pontoon may contain to seep into the storage tank, since water is denser than fuel. It is very undesirable to allow water into the storage tank.

The technology relates to providing tanks with equipment that is able to monitor, trend and notify of the storage tanks structural status, structural shell deformation compliance, floating roof status and floating roof seals status.

The present disclosure relates to apparatus and methods for measuring the status of a floating-roof tank using an array of fiber optic sensors. In particular, the present technology relates to monitoring the floating roof of a storage tank using various types of sensors which primarily measure core metrics such as: pressure, strain, liquid level, presence of liquid, presence of vapors, tilt, deformation and displacement. Sensors may also be able to measure secondary metrics. For example, a displacement sensor can measure vibration, and these vibration measurements can be used to determine whether or not the shoe seal is making full/no/partial contact. Core metrics may be considered to be a measurement associated with a point in time (e.g., state metrics). Secondary metrics may correspond to the trend in how a state metric changes over a period of time (e.g., a rate metric, such as how quickly the pressure decreases). Secondary metrics may correspond to frequency components within the state metric (e.g., a frequency metric, such as a vibration in a displacement or a pressure sensor).

These measurements may help to enhance the storage tank owner's ability to protect the environment in line with the mandatory environmental protection agencies (such as the EPA) and greatly improve the efficiency of Industrial Code Compliance. This technology may also help enable continuous monitoring of the storage tank's floating roof and seals. It may also allow for remote identification of problems associated with the floating roof tank and allow crews to remedy these problems more quickly because they can proactively bring the equipment they need. These problems may include:
pontoon leaks;
seal leaks;
Seal conditions such as rollover;
tilting of floating roof;
deformation of floating roof;
deformation of floating roof penetrations such as support columns or gauge poles as a result of the floating roof rotation or tilt or shell deformation creating contact with a penetration point (e.g., gauge pole); and
corrosion.
Deformation of floating roof due to uncontrolled roof landings or “bottoming-out”.
Wind induced rippling damage on the roof membrane after wind events.
Accumulation of rainwater.
Ponding or presence of tank contents on roof (including sump).
Presence of liquid inside pontoons.
Presence of liquid leaks through the tanks floor.
Presence of liquids leaks through the foundation drains.
Presence of vapors inside pontoons or between the primary and secondary seal.
High/Low fill level thresholds.
Rolling ladder malfunction.
Condition and status (open or closed) of access hatches.
Condition and status of gauge hatch & gauge float.
Condition and status of vacuum breaker.
Condition of visible portion of deck legs.
Condition of fixed roof column supports and seals (for IFR's).
Condition and status of sump drains.
Condition and status of deck drains (for IFR's).
Condition of visible portion of ladder and ladder seal.
Presence of personnel or unauthorized person(s).
Foundational shifting or settlement.
Ground water permeability.

An advantage of the present technology is that although a variety of parameters (e.g., pressure, linear deformation, tilt) are being monitored, they are all being monitored using compatible fiber optic cable technology. This means that a common interrogator can be used within a fiber optic network of different types of sensors. In other embodiments, different interrogators may be used for different sensor types. For example, a lidar sensor may have a dedicated interrogator.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Floating Roof Tank

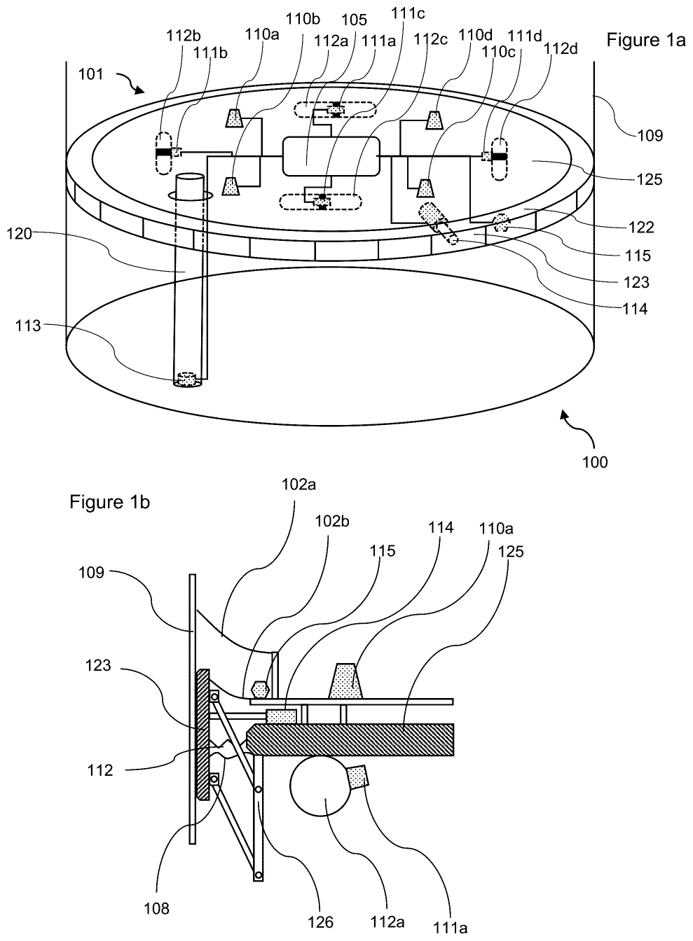

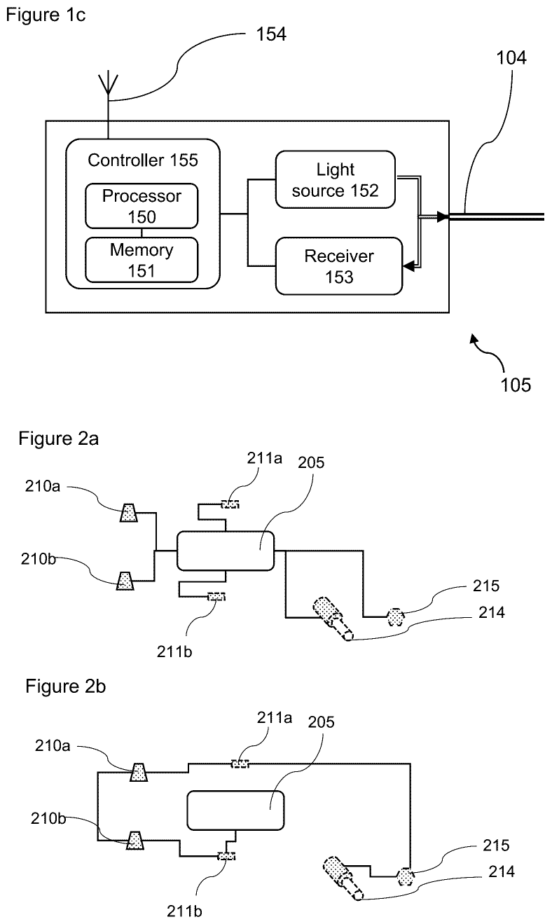

FIG. 1a shows a perspective view of an embodiment of an external floating roof tank 100. A floating roof tank is a storage tank which is commonly used to store large quantities of petroleum products such as crude oil or condensate. In this case, the tank comprises an open-topped cylindrical steel container with a shell 109 equipped with a roof 101 that floats on the surface of the stored liquid.

In this case, the roof comprises an impermeable roof section 125 and a deformable seal 122 which spans the gap between a rigid (and impermeable) section 125 of the floating roof and the shell 109 to help prevent gas from escaping from the tank.

FIG. 1b is a cross-section of the seal 102. The roof rises and falls with the liquid level 108 in the tank.

In this case, the roof also comprises deformable floats 112a-d attached to the roof section.

In this case, the seal assembly comprises a mechanical seal. The mechanical seal assembly comprises an upper wiper seal 102a and a shoe seal 102b. In this case, the shoe 123 (a planar plate) is pushed towards the tank shell 109 by a pusher spring 112. The orientation of the shoe 123 with respect to the roof section 125 is maintained by a mechanical linkage 126 (also known as the hanger assembly). Between the shoe and the roof, there is a continuous seal 102b (e.g., comprising one or more flexible sheets of material, such as rubber).

Both the upper wiper seal 102a and the continuous seal 1402b are connected to the rigid impermeable roof section of the roof. However, while the upper wiper seal is configured to slide along the inner surface of the shell 109, the continuous seal 111 is connected to the shoe 111, and the shoe is 111 configured to slide along the inner surface of the shell 109. This may provide a more robust seal than the wiper seal because the seal has a larger contact area with the shell. Although not shown here, both the upper wiper seal 102a and the continuous seal 102b may be monitored using respective fiber optic cable sensor connected along the length of the deformable seal, or through components indirectly attached to the deformable seal.

It will be appreciated that other seal types may be used. For example, other embodiments may comprise a foam block sealed within an envelope.

In some embodiments, the roof may have support legs hanging down into the liquid. These allow the roof to land at low liquid levels the roof which then allows a vapor space to form between the liquid surface and the roof, like a fixed roof tank.

### Controller

FIG. 1c shows a schematic representation of the controller 105 which may be used in conjunction with other embodiments described herein, including the embodiment of FIG. 1a. The controller 105 comprises a light source 152 configured to generate light which is directed into the fiber optic cable 104. In most cases, this light source will be a laser.

The controller also comprises a light receiver 153 (e.g., a photodetector) configured to detect light from the fiber optic cable. The light received will contain artefacts which are due to how the fiber optic cable has been deformed. In many cases, the light received will be back-scattered light.

In this case, the apparatus controller 105 comprises a controller 155 comprising a processor 150 and memory 151. The memory on this case comprises computer program code configured to be run on the processor. The computer program code may be stored on a non-transitory medium (e.g., CD or DVD).

The controller 155 in this case is configured to:
receive data from the receiver 153; and
determine a measure of spatially resolved deformation of the fiber optic cable 104 based on the received data.

The fiber optic sensors described above are built around fiber optic technology, and so can form part of a single fiber optic cable network. This allows a single fiber optic network controller to interact with a variety of different sensors and/or sensor types.

The FMCW lidar sensor may require a separate controller. The controller and the sensing head of the FMCW lidar sensor may be connected by means of fiber optic cable. In cases where the sensor head and controller are combined into one unit (i.e., lidar-on-a-chip), the unit will require measures to ensure it is intrinsically safe.

All sensors may be connected through a series of fiber optic cables and connected to the central controller. The configuration of these sensors can vary depending on the sensor type. The configurations may include series, “daisy-chain’, star, parallel or any combination thereof.

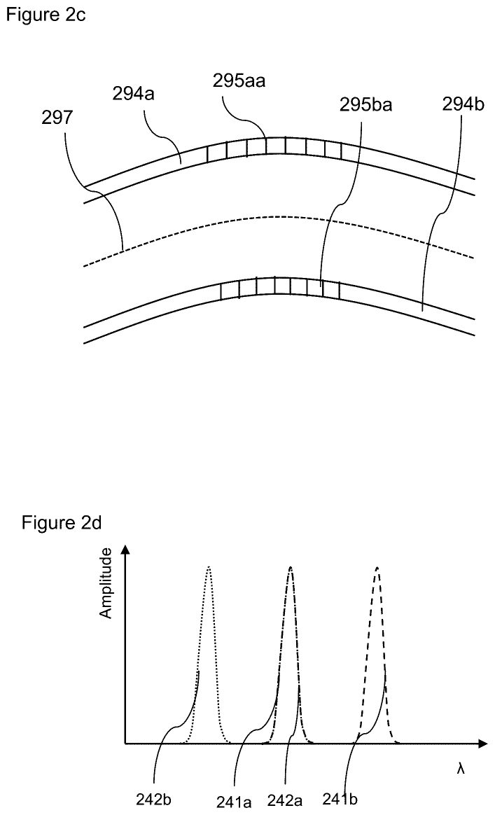

FIGS. 2a and 2b show two different ways of connecting the same array of fiber optic sensors comprising two pressure sensors 211a,b, two tilt sensors 210a,b, a show displacement sensor 214 and a chemical sensor 215. In FIG. 2a, each sensor is directly connected to the central controller 205 in a star formation, whereas in FIG. 2b, the sensors are connected in series.

One advantage of a fibre optic cable network is that different distances between the interrogator and the sensor can be associated with a different time (i.e., related to the time taken from light to pass from the light source to the sensor and back to the receiver). This means that sensors can be arranged in series where the light passes through a number of different sensors on its way from the light source to the receiver.

The central controller may be configured to read all signals from fiber optic sensors and provide data to end user via wireless or wired communication.

As discussed in Lu et al. (A Review of Methods for Fibre-Optic Distributed Chemical Sensing, Sensors 2019, 19, 2876; doi: 10.3390/s19132876), DCS, as a distributed fiber sensing (DFS) technique, is capable of employing the entire optical fiber as the sensing element and of providing measurements with a high degree of spatial density. The spatial information is usually resolved through optical time domain reflectometry (OTDR) or optical frequency domain reflectometry (OFDR). In an OTDR apparatus, an optical pulse is launched into the fiber, and the backscattered light intensity is measured as a function of time.

The distance along the fiber to which a given backscatter component corresponds is determined by time-of-flight considerations, and the spatial resolution is commonly defined as half of the pulse length. Finally, the obtained signal is processed to retrieve the spatial information.

The backscattered signal comprises Rayleigh, Raman, and Brillouin scattering processes inside an optical fiber. Different types of distributed sensor are often classified in terms of what backscattered component they are designed to measure. Rayleigh scattering is an elastic process, in which there exists no energy transfer between the incident light and the medium; thus, the backscattered light exhibits no frequency shift compared to the laser input. On the other hand, inelastic scattering, e.g., Brillouin and Raman scattering, requires an energy exchange between the light and the material; thus, the frequency of the scattered light is expected to shift from the incident light, as illustrated in FIG. 2d. For silica fibers with an incident light at 1550 nm, the frequency shifts of Brillouin scattering and Raman scattering are about 11 GHz and 13.2 THz, respectively.

In this case, the apparatus comprises a wireless transceiver 554 for transmitting data from the apparatus to a remote computer. In this case, the controller is configured to determine the deformation of the fiber optic cable and the sealing assembly and to transmit the determined deformation profile of the seal assembly to a remote computer. It will be appreciated that this may increase the processing capacity required by the local controller and reduce the amount of data that needs to be transmitted to the remote computer.

In other embodiments, the controller may be configured to transmit the data detected by the light receiver to the remote computer. In such embodiments, the remote computer may be configured to perform the calculations to deduce the deformation profile based on the received data.

In this case, the apparatus is configured to provide an alert or notification when the status of the tank meets one or more predetermined alert criteria. For example, an alert may be generated when a deformation is detected which corresponds to the roof falling or rising when authorized removal or filling of liquid is not taking place. Or an alert may be generated when deformation of the shell exceeding a predetermined threshold is detected.

In this case, the apparatus is configured to continuously monitor deformation. Interrogators can sample at very high rates. 500 msec separation between sampling would allow many sensors to be monitored at once.

An alert or notification may comprise audio and/or visual alerts at the location of the floating roof tank (e.g., warning lights on the roof of the tank or on the shell), and or audio and/or visual alerts provided at a remote computer (e.g., automatic texts, or visual warnings). The nature of the alert may be dependent on the status of the tank. E.g., if the status of the tank is just outside normal operating conditions, a yellow visual alert light may be illuminated at the site of the floating roof tank, and an email sent to the engineer responsible. If the status of the tank exceeds normal operating conditions by a significant amount, red lights and a siren at the site may be initiated, and automatic phone calls initiated to all engineers in a predetermined contact list. Similarly, the type of event determined by the controller or remote computer may dictate the nature of the alert (e.g., liquid being detected in a float vs. unauthorised personnel on the roof).

An alert may be configured to alert personal working at the floating roof tank site. An alert may be configured to restrict access to the floating roof by closing a barrier in response to the floating roof being determined to be unsafe. The barrier may restrict entry on to the roof, but allow exit from the roof. The floating roof tank assembly may be configured to determine whether there are workers on the floating roof when an alert is initiated or during an alert (e.g., based on monitoring vibration signals on the ladder onto the floating roof). The alert may be configured to notify users (e.g., first responders) of the presence of people on the floating roof during an alert.

### Sensor Basics

At a fundamental level, the fiber optic sensors may use deformation or strain of fiber optic cables to determine different status parameters of the floating-roof tank assembly.

The cable assembly design is based on the bend measurement differential principle by means of two Bragg Grating elements located on different sides of its structure (see FIG. 2c). In this case, the figure shows how curvature in the plane of the page can be measured by two fiber optic cables 294a, 294b arranged on either side of a fiber optic cable assembly axis 297. Each cable comprises a respective Bragg grating 295aa, 295ab arranged at the same length along the optic cable assembly axis 297.

In the situation depicted in FIG. 2c, the fiber optic cable assembly is bent downwards at either side. This causes tension in Bragg grating 295aa in the upper fiber optic cable 294a which increases the Bragg grating spacing; and compression in the Bragg grating 295ba in the lower fiber optic cable 294b which decreases the Bragg grating spacing. The difference in the change in Bragg grating spacings allows a measure of the curvature in the optic cable assembly axis 297 to be determined.

This is shown in FIG. 2d, which is a graph of the wavelength of light reflected from the Bragg gratings of the two fibre optic cables 294a,b in an undeformed configuration 241a, 242a (assuming the Bragg grating spacing in both cables is the same), and a graph of the wave length of the light reflected from the Bragg gratings of the two fibre optic cables 294a,b in an deformed configuration 241b, 242b. In the undeformed configuration, the reflected wavelength graphs overlap because the Bragg grating spacing is the same. As the deformation induces a stretch in one fiber optic cable, the stretched cable starts to reflect light at a longer wavelength, whereas a compressed fiber optic cable reflects light at a shorter wavelength due to changes in the Bragg grating spacing induced by the strain.

Such an arrangement of the sensing elements increases the measurement accuracy and reduces the temperature influence, since it is the difference between different fiber optic cable readings that is used to measure the magnitude of the deformation, rather than absolute values. Measuring the magnitude of the bend in 1 plane (y) requires the use of at least 2 sensing elements. Measuring the magnitude of the bend in two planes (y,z) requires the use of at least three sensing elements. By combining multitudes of 3-sensor configurations, and interpolating between these configurations, 3 dimensional shape sensing can be achieved along a the fibers length (x).

### Pontoon Pressure Sensors

Fiber optic pressure sensors can measure pressure changes within a gas (e.g., air) filled vessel/container.

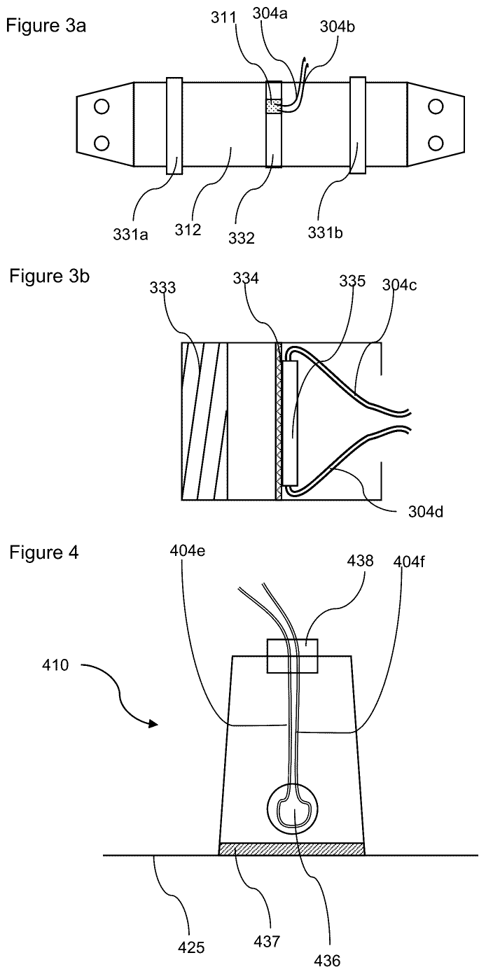

FIG. 3a shows a first embodiment of a pressure sensor 311 mounted onto the outside of a cylindrical pontoon float 312. The pontoon in this case is a sealed hollow vessel filled with a gas such as air. The pontoon is mounted onto the roof using two saddle clamps 331a,b at either end. In this configuration, the largest deformation occurs at the centre of the pontoon float. The sensors may also be mounted directly to the pontoon exterior.

In this case, the sensor 311 is mounted onto the pontoon using a simple belt clamp 332 around the pontoon 312. This may allow the sensors to be retrofitted to an already operational floating roof assembly. The sensor may be configured to detect tension in the belt around the pontoon.

In this embodiment, the pressure sensor comprises multiple fibre optic cables 304a,b which run across the surface of the pontoon. As the pressure changes within the pontoon, the walls of the pontoon deform, which is detected as a strain in the pressure sensor. This strain can be used as a measure of pressure directly, or a pressure may be calculated by the central controller.

FIG. 3b shows an alternative embodiment which uses a diaphragm 334. This embodiment is screwed into the wall of the pontoon using threaded screw connectors. In this embodiment the diaphragm is formed from a 0.08″ or 2 mm aluminium. The diaphragm bulges as the pressure changes within the pontoon. This deformation is detected by a strain sensor (with one or more FBG fibre optic cables) adhered to the diaphragm by, for example, epoxy or spot weld. Other embodiments may have thinner metallic diaphragms, e.g., with larger diameters. The length and width of the sensor component 335 on the diaphragm may be greater than 5 mm and/or less than 20 mm. The thickness of the sensor element may be less than 1 mm. As before fibre optic cables 304c,d are connected to the sensor component.

Other embodiments may have the sensor turned 90 degrees relative to the enclosure. This would create an assembly that is longer than wide, and may be better suited for some applications. This embodiment would operate on a similar concept of using vessel pressure or vacuum to deform the gratings of the FGB sensor.

The pontoon/floatation device may be pressurized (e.g., 0.5-2 psi above atmospheric pressure) and therefore the diaphragm is slightly bulged as a baseline. If there is a release in pressure the sensor will show that wavelength shift and detect a pressure loss. The rigid housing isolates other deformations of the pontoon from the diaphragm, and so the sensor only detects changes in pressure within the pontoon.

In this embodiment, when screwed into the pontoon float wall, one side of the diaphragm is in fluid communication with the interior of the pontoon, and the other side of the diaphragm is exposed to the atmosphere. This means that as the pressure within the pontoon changes, the diaphragm will deform. In this embodiment, the pressure sensor comprises a connector for connecting to the wall of the pontoon (e.g., a screw thread 333 with gasket, O-ring or other sealing element). In other embodiments, air/gas may be delivered into the packaged sensor by means of pneumatic tubing and a directional valve to keep air pressure contained.

In some embodiments a pressure sensor may sense the pressure of a single vessel or a group of 2 or more vessels. A sensor(s) may read a group of 2 or more vessels as a combined/average pressure. This may be done by creating a fluid connection between multiple vessels (e.g., via a pipe connected between the vessels).

For pressure sensor, a core parameter to monitor is the pressure of the pontoons. Any pontoon showing a lower pressure than a threshold pressure may need to be replaced. This may allow the operator to gather the likely required replacement parts before opening the tank for inspection.

Another use case is where the pressure is monitored for multiple pontoons. For example, a deflated pontoon may be confirmed if a pressure decrease in one pontoon is correlated with corresponding increases in pressure in neighbouring pontoon float (e.g., where there is no fluid communication between the neighbouring pontoon floats). This would correspond to the roof tilting and the neighbouring pontoons being more submerged to compensate for the buoyancy lost by the deflated pontoon.

In external floating roof tanks, monitoring the pressure may also allow the effective weight of the roof to be monitored. For example, snow fall on an external roof may cause an increase in pressure in the pontoons as the effective weight of the roof increases. Drifting (e.g., of snow) may cause some pontoons to have a greater pressure as the weight may be unevenly distributed. Where temperatures (e.g., as measured on top of the floating roof) are above 0° C., excess weight of the roof may be associated with faulty drainage or water pooling on the roof.

In addition, the controller may be configured to determine the pressure over time, and use the temporal development of the pressure to determine the source of the change. For example, the controller may be configured to determine if the air/gas was released into liquid or atmosphere. This may help assess the possibility of liquid entering the pontoon (or other float).

The signals received by the sensors can detect different types of vessel pressure failures with respect to the type of signature the signal presents. This may allow the controller or remote computer to identify possible or likely causes based on the received information. For example:
The controller may be configured to associate a smooth released curve with a leak released into the atmosphere (i.e., above the liquid line).
The controller may be configured to associate a sporadically decreasing signal with gas being released into a liquid. The sporadically decreasing signal would be associated with bubbles which would not be detected in a release into the atmosphere.
The controller may be configured to associate a rapid loss of pressure with a mechanical tear or larger opening in the vessel.
The controller may be configured to associate a more gradual loss of pressure with a slow pinhole pressure release.

It will be appreciated that the first two points relate to a frequency metric within the overall trend. That is, the presence of a periodic deviation in the strain trend (e.g. with a frequency of between 0.1-100 Hz) may be associated with bubbles. The absence of such a deviation may be associated with a lack of bubbles and a determination that the gas is leaking into the atmosphere.

It will be appreciated that the second two points relate to a rate metric. That is, the rate at which the pressure is being lost may be associated with the size of the leak. For example, a pressure lose of 50% of the initial pressure over less than 10 seconds may be associated with a large leak, whereas a pressure loss of 50% over more than 60 seconds may be identified as a small leak. It will be appreciated that leaks may be monitored over much longer periods (e.g. where a pressure loss of 50% would take days). The controller may be configured to extrapolate the trend line over time to predict when a pressure loss would go below a predetermined threshold. This would help operators ensure that the fault is repaired in good time.

### Tilt Sensors

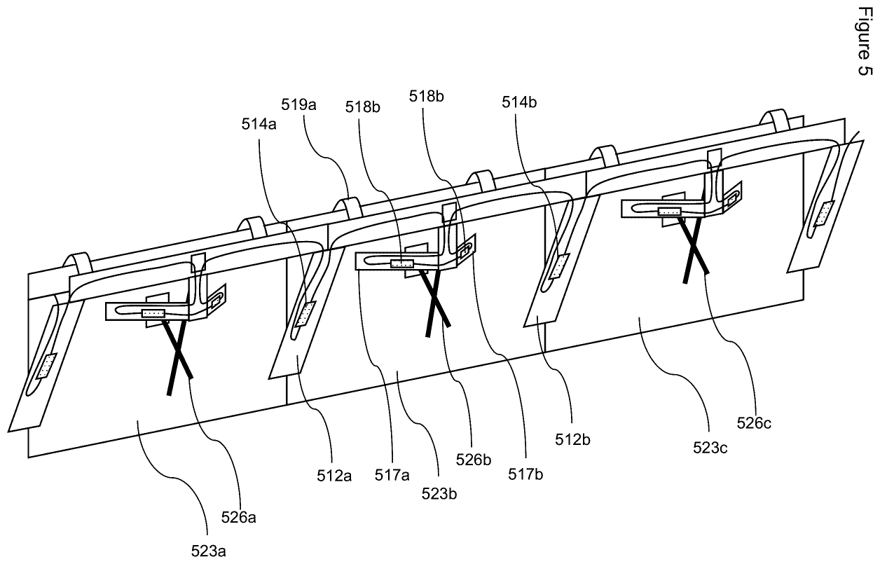

Fiber optic tilt sensors can measure the levelness of surface. In the embodiment shown in FIG. 4, the tilt sensor 410 comprises a base 437 for mounting to the surface (in this case of the roof section 425). Above the base a mass 436 hangs from the fibre optic cable from a mount which is fixed with respect to the base. In this case, there are two fibre optic lines 404e,f connecting the mount 438 to the mass 436. As the surface 425 tilts, the mass 436 will move under the action of gravity. Where the tilt is about an axis transverse to the plane of the two fiber optic lines, the movement of the mass with respect to the mount will cause the lines to be extended with respect to the other line. This causes the Bragg gratings of the two lines to have a different spatial frequency, which in turn can be taken as a measure of tilt. It will be appreciated that the tilt sensor may comprise a mechanism to prevent rotation of the mass when the tilt sensor is tilted.

It will be appreciated that a two-line fiber optic cable can determine the tilt in one direction. Therefore, two two-line fiber optic cable tilt sensors arranged transversely can be used to determine tilt in all directions. Alternatively, a tilt sensor may comprise more than two fiber optic lines so that each pair of fibre optic lines provides tilt directions.

If the roof section has one tilt sensor, and the roof can be considered to be relatively rigid, and the tilt measurement can be taken as a measure of how much the roof has tilted.

In the embodiment of FIG. 1a, multiple fiber optic tilt sensors 110a-d are located at different positions around the roof section. Where multiple tilt sensors are used, differences in tilt can be used to determine deformation of the roof section, as well as an average tilt for the entire roof section. For example, if one side of the roof has tilted, and the other side has not, a bend or curve of the roof can be determined between the two sides. More tilt sensors can determine more complex formation. For example, 4 or more sets of sensors could be used to determine that a saddle deformation in a roof section has occurred.

Tilt sensors may also be used to monitor other aspects of the structure. For example, tilt sensors may be mounted on the surface ladders, columns, and/or shell.

Tilt sensors may be affixed to other components to provide different information. For example, a tilt sensor may be installed to a tilting structure (e.g., a rolling ladder) connected between the roof and the shell. This configuration would allow the tilt sensor to measure height of the floating roof with respect to the shell (which in turn is related to the liquid level within the tank). The tilting structure may be an elongate structure connected via a pivot to the top of the shell at a shell end, and rest on the top of the roof section at the roof end. The roof end may comprise wheels to allow the roof end to move with respect to the roof section as the roof section rises and falls. The roof section may comprise tracks to engage with the roof end of the structure. As the roof section rises and falls, the angle of the tilting structure will change as the roof end moves across the roof section. By determining the tilt of the tilting structure, the height of the roof section can be determined, which in turn is a measure of the volume of liquid in the tank.

Important events such as low, low-low, high, & high-high roof levels may be configured. Low & high status require immediate action be taken to correct level whereas low-low & high-high are more severe and require an automatic or manual shutdown of the system. Level measurement systems such as this one may meet API 2350 regulations (American Petroleum Institute, API Standard 2350, 5th Edition, Overfill Prevention for Storage Tanks in Petroleum Facilities). The controller may also be configured to detect anomalies of a tilting structure based on angular data patterns or combinations of angular data and various other sensor data such as product receipt & discharge flow rate (i.e., product discharge/receipt is occurring but the rolling ladder tilt is not changing accordingly, therefore the rolling ladder is malfunctioning or the rolling ladder tilt is changing but there is no discharge/receipt of product therefore there may be a leak in the tank or the floating roof may be losing buoyancy).

The controller may also be configured to detect a vibratory “bottom-out” event whereby a floating roofs legs contact the floor of a tank, a highly undesirable condition.

The controller may also be configured to detect the presence of authorized or unauthorized personnel by analyzing the vibration patterns from sensors mounted to the rolling ladder. A person walking along the rolling ladder will produce a recognizable vibration pattern. Since the rolling ladder is the only access/egress to/from the floating roof, the presence and/or number of personnel on the roof can be determined (e.g., 1 in 1 out, 2 in 1 out).

A displacement sensor may be used in place of a tilt sensor to achieve greater angular measurements. The displacement sensor may require placement between a fixed point and a variable point such as a rolling ladder frame (variable) and the top of the rolling ladder platform (fixed). The displacement sensor may also be attached to a self-contained, self-referencing, non-powered mechanism that converts angular measurements such as a 4-bar linkage referencing a weighted pendulum. Alternatively, a tilt sensor could be used with an angular scaling mechanism as well.

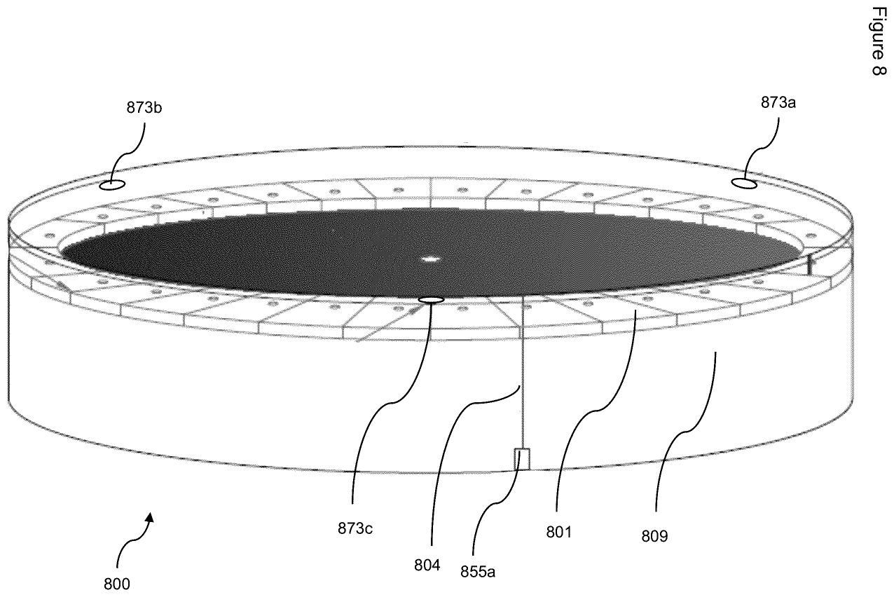

FIGS. 7a and 7b shows one mechanism for scaling the tilt of a surface 771 (e.g., a rolling ladder) such that it is within the range of a particular tilt sensor 710. FIG. 7a shows the situation where the surface is at a moderate tilt (˜10° to horizontal), and FIG. 7b is where the surface is at an extreme tilt (˜80° to horizontal). It will be seen that the tilt sensor has not rotated to the same extent as the surface between the two situations. This allows the controller to map the directly measured tilt of the tilt sensor 710 to on to the tilt of the tilt of the surface 771 based on knowledge of the mechanism liking the surface to the tilt sensor. In this case, the mechanism comprises a 4-bar linkage pivotally attached to each other. The four bars in the linkage comprise:
A surface bar rigidly 772a connected to a surface (e.g., of the rolling ladder) such that rotation of the surface rotates the surface bar by the same amount;
A weight bar 772b comprising a relatively heavy mass configured to hang substantially vertically below a pivot connecting the weight bar to the surface bar;
A tilt sensor bar 772c, in this case connected to the bottom of the weight bar, and onto which the tilt sensor is rigidly mounted; and
A free bar 772c connecting the other end of the tilt sensor bar to a second pivot on the surface bar.

How the mapping of the surface tilt to the tilt of the tilt surface bar can be changed by adjusting the length of the various bars in the mechanism (i.e., the length of the bars between the respective two pivots). For example, making the tilt bar longer relative to the length of the surface bar means that a greater rotation of the surface bar is required to make the same rotation in the tilt sensor bar. Conversely, making the surface bar longer relative to the tilt bar means that a smaller rotation of the surface bar can produce a greater rotation of the tilt sensor bar.

For a tilt sensor mounted on a tilting structure, such as a rolling ladder, the rate metric of the change in tilt over time (i.e., velocity) may be converted into a flow rate into or out of the tank.

A tilt sensor may be installed on a vertical section of a shell to measure verticality.

A tilt sensor may be installed on a structural component to indicate deformation.

### Shoe Sensors

As described above, the seal comprises a series of abutting shoes arranged around the perimeter of the tank. Each shoe is a plate which is disposed against the inner wall of the tank shell, and which is mechanically connected to the outer rim of the floating roof. In the embodiment of FIG. 1b, the mechanism connecting the shoe to the roof section comprises a series of linkage mechanism 126 and a resilient portion 112, such as a spring, plate, or bar for biasing the shoe 123 away from the roof section 125 and towards the inner wall of the tank shell 109.

Fiber optic displacement sensors can measure the physical displacement of an objects. The fiber optic displacement sensors may be Fibre Bragg Grating Fiber optic displacement sensors. Fiber optic displacement sensors may comprise a cylinder encasing a piston. The piston may have a plunger which is connected to chamber which upon pulling the piston outwards, draws and creates a vacuum within the chamber, the vacuum compresses the internal one or more Fibre Bragg Gratings and registers a wavelength change. Using a pair of Fibre Bragg Gratings within the displacement sensor may reduce or remove effects of temperature changes. In the embodiment of FIG. 1b, a displacement sensor 115 comprises a transducer ram connected to the shoe 123, and a base connected to the roof section 125. The transducer ram telescopes in and out of the base as the shoe moves towards and away from the roof section. Therefore, the sensor provides an indication of the distance between the roof section edge and the shoe.

Other configurations may exist whereby the range of the displacement sensor is scaled by means of a linkage and/or the displacement sensor is mounted in different orientations. In the embodiments of FIG. 1a, each shoe 123 has a corresponding fibre optic displacement sensor 114. It will be appreciated that in other embodiments, only a portion of the shoes may have displacement sensors (e.g., every Nth shoe, where N is an integer).

Fiber optic displacement sensors may also take on other forms. They may simply be an FBG inscribed within a fiber optic cable that is epoxied to particular point of interest within the shoe assembly or seal assembly. These points of interest may be areas that flex, move, or rotate such as a compression plate, compression bar, vapor barrier fabric mount or strap, linkage, coil spring, articulating arm, etc. The strain of these components can be translated into displacement. By knowing the expected physical range of travel relative to the measured strain sensed at these points, a calibration can be performed.

Installing fiber optic displacement sensors around the perimeter of the floating roof can provide rim space measurements and monitor the health of shoe seals. The numbers of sensing points around the perimeter will determine the resolution of the system.

The sensors may be mounted to shoes, shoe seals, shoe mounting plates, springs, or other equipment/mechanisms between or near the floating roof outer rim and the storage tank shell.

In a first use, the displacement of a displacement sensor mounted between the shell and the roof section can give a measure of the position of the roof section with respect to the shell.

In addition, where there are multiple displacement sensors mounted between the shell and the roof section, additional information may be determined (e.g., by the controller). For example, tilting of the roof may be associated with one displacement sensor (corresponding to the lower side) being compressed due to the weight of the roof section, and the opposite displacement sensor being extended (corresponding to the raised end of the roof).

In contrast, if the displacement sensors are extended by different amounts around the perimeter of the shell, where each sensor has a similar displacement to a corresponding sensor on the opposite side of the tank, the controller may associate this with a deformation of the tank (e.g., into an ellipse).

As a further use, fiber optic displacement sensors may be very sensitive to vibrations (a frequency metric). A dynamic floating roof produces various vibratory signatures as it travels. A primary and/or secondary seal may produce obvious vibratory signatures since these are the mediums by which the floating roof makes contact with the tank shell. The displacement sensors may be located close to these points of contact (i.e., seals). Vibrations sensed by the displacement sensor (and possibly other sensors) can distinguish between a seal making aggressive contact, normal contact, light contact, or no contact at all. The controller may be configured to categorise the strength of contact based on the characteristics of the vibration detected by the displacement sensor (e.g., frequency, amplitude and/or waveform).

The controller may be configured to determine the location of a fault based on an analysis of the signatures between two or more adjacent sensors and determining the distance to the fault by the strength of the vibratory signatures.

For example, the system may be configured to store historical data to be able to determine a change in the vibration signals over time. The sensors may also be sufficiently sensitive to detect change from several feet away from its contact location. For example, sensors may be configured to detect a sudden change or a shock anomaly. Tanks are subject to settlement, ambient temperature changes and corrosion. The steel plate materials and weld seams can change shape when distributed hoop stress changes. Settlement changes the direction of the hoop stress to shear strain stress, the shell can have a sudden flat spot of bulge appear. The ambient temperature warming or cooling can cause restriction or expansion to make a sudden deformation anomaly appear. The gradual thinning of plate material becomes more ductile or the tank being full versus empty can create sudden deformation anomalies to appear or change.

A system of rim-space displacement sensors will indicate the health of the shoes. Monitoring the shoe seals may provide data that could precede and warn of a primary/secondary seal rollover, which often happens in association with a damaged shoe.

### Depth Sensors

Depth sensors may comprise a pressure or strain sensor coupled with a sealed deformable chamber positioned at the bottom of the tank. As the level of fluid above the deformable chamber changes, the pressure experienced by the chamber changes and the chamber deforms. The deformation of the chamber corresponds to strain which can be detected by the fibre optic cables, which in turn can be used as a measure of depth.

In the embodiment of FIG. 1a, the depth sensor 113 is placed at the bottom of the gauge pole 120.

As before, the rate metric of change of pressure over time may be associated with a flow rate into or out of the tank.

### Ground Water Porosity/Permeability Sensors

Ground water porosity/permeability sensors (i.e., pore water pressure sensors) may be used to detect the level of water saturation in the soil. By adding these sensors to strategically located sensor wells around the foundation of an above ground storage tank, value is added to understanding foundational and settlement issues of the entirety of the tank. It has been observed by experts in the field, that a storage tanks settlement is affected by groundwater, especially when located next to rising & falling rivers and tidal waters, as most storage tanks are. When a storage tank is exposed to foundational forces such as ground water porosity/permeability, the effects may manifest in more visible areas such as shell deformations, but the root cause remains obscure, and often ignored.

### Chemical Sensors

Chemical sensors may be affixed to various locations of the floating roof to detect the presence and concentration of chemical emissions or products.

Lu, X et al. (Reference 3) describes a variety of techniques are available to detect the presence of chemicals using fibre optic cables.

In the context of a floating roof assembly, a chemical sensor is positioned within an enclosed cavity of the floating roof, each enclosed cavity being isolated from the interior of the container. The fiber optic chemical sensor is configured to identify a change in the chemical composition of the contents of a said cavity.

Enclosed cavities may include:
Pontoon spaces
Hexagon membrane spaces
Annular spaces
Double pan spaces
Topside of floating roof
Foam or floatation material
Rim, Seal or Vapor Barrier Spaces

In the embodiment of FIG. 1b, there is a chemical sensor 115 positioned within an enclosed cavity bounded by the upper wiper seal 102a, the shoe seal 102b and the shell 109. This cavity is isolated from the contents of the tank by the shoe seal and, in normal operation, should not detect significant quantities of non-atmospheric chemicals.

If the chemical sensor does detect non-atmospheric chemicals, this may indicate damage to the seal separating the chemical sensor 115 and the contents of the tank. For example, detecting chemicals within this space may indicate damage to one or more of the shoe seal 102b, the shoe, and the linkage connecting the shoe to the roof section. This may be particularly useful because the parts of the roof assembly that are being monitored in this use case would not be visible to an inspector without moving components of the assembly (e.g., the upper seal 102a).

The chemical sensor may be configured to determine the rate of change of chemical concentration within the cavity over time. The controller may use this rate metric to determine the size of the fault.

It will be appreciated that the chemical sensor and/or controller may be configured to detect the chemicals stored in the tank. For example, if the tank is for hydrocarbon storage, the chemical sensor and/or controller may be configured to detect hydrocarbons.

### Liquid Sensors

Fiber optic liquid sensors may detect water, hydrocarbon, or other compounds depending on the material coupled to the fiber optic core. The coupled material may, in the presence of liquid, exert a mechanical force on the fiber optic cable itself or a sensing element of the fiber optic cable such as an FBG (Fiber Bragg Grating). This force may be strain (such as tension or compression), torsion, or a combination thereof.

The coupled material may change the RI (refractive index) of the fiber optic cladding in the presence of liquid.

The coupled material may be a silicone elastomer such as PDMS (polydimethylsiloxane) or a rubber such as EPDM (ethylene propylene diene monomer) that swells in the presence of hydrocarbons. The coupled material may also be a hydrogel such as alginate that absorbs water. The swelling or absorption of compounds into the coupled material may exert a mechanical force on the FO cable or change the RI of the cladding, producing a measurable optical change in wavelength, amplitude, and/or frequency.

The expansion or contraction of the coupled material may also be amplified by means of varied topology. For example, PDMS molded to form a porous topology (e.g., sponge) will have a greater degree of expansion & contraction than a solid block of PDMS. It can be appreciated that a material such as PDMS will expand in the presence of hydrocarbons and contract when hydrocarbons are removed, thus making the sensor reusable. This would also apply to some water absorbing materials, such as Alginate.

The coupled material may also be a material that degrades in the presence of fluid. A material such as polystyrene may degrade when contacting a hydrocarbon. A material such as polyvinyl alcohol may degrade when contacting water. The degradation of the materials would interrupt the continuity of light and indicate a faulty condition. The swelling or absorption of compounds into the coupled materials could also interrupt the continuity of light and indicate a faulty condition.

The liquid sensor may comprise the “Technicasa™ T-280 Flood Sensor” or something simpler such as an FBG coated in Alginate or PDMS.

The placement of these sensors will help determine their combined shape, size, and functionality. An annular pontoon section may require a one-dimensional linear array of fluid sensing points located along the lowest edge of the pontoon, closest to the rim. This linear array may be as long as the arc length of the back edge of annual pontoon, 10′ in some cases.

In addition to detecting liquid at the lowest elevation of a pontoon, additional sensors may be placed at any other elevation, or combination of elevations within the pontoon, to detect rising liquid levels. Multiple sensor elevations within the pontoon would be best suited for discreet type sensors. In other words, on-off operation or sensors that simply detect the presence of ‘liquid’ or ‘no-liquid’. An analog sensor that detects the amount of liquid, through hydrostatic pressure or other means, would be best suited at just the lowest elevation of the pontoon's interior.

### Vapor Sensors

Fiber optic vapor sensors may detect vapors of hydrocarbons, volatile organic compounds (VOC's), or other compounds depending on the material coupled to the fiber optic core.

A vapor sensor works in a similar way to the liquid sensors described above. The purpose of the coupled material may be to exert a mechanical force on the fiber optic cable itself or a sensing element of the fiber optic cable such as an FBG (Fiber Bragg Grating). This force may be strain (such as tension or compression), torsion, or a combination thereof. The purpose of the coupled material may also be to change the RI (refractive index) of the fiber optic cladding. The coupled material may also be a material that degrades in the presence of the vapor.

Sensing of vapors requires a much higher degree of sensitivity compared to sensing liquids. Dynamic interrogation may be required to detect the smaller optical signals, as opposed to static interrogation. Noise-to-Signal ratio will require consideration as well. Successful detection of vapors using Fabry-Perot type sensor has been demonstrated, as has newer configurations including tilted FBG's, long grating FBG's, tapered/elongated waveguides and others.

A vapor sensor may be positioned at an elevated point above the base within a pontoon or float cavity.

### Ponding Sensors

Fiber optic ponding sensors (e.g., roof liquid sensors positioned on the roof to detect ponding) may share some characteristics of pontoon liquid sensors. As with pontoon liquid sensors, different variations may be used. The “Technicasa T-280 Flood Sensor” may be used in either application as a discrete type of sensor. When used as a ponding sensor, the sensor is to be raised a predetermined amount from the lowest elevation point. This will help prevent a false reading during rain events and allow the roof drains to perform their function. If the drains are impeded or cannot keep up with the rainfall, then the sensor will detect liquid through perforations in the housing. This differs from the pontoon liquid sensor that are required to detect any presence of liquid immediately, since pontoons should always remain dry. The roof liquid sensor may be covered with a roof to prevent detection of precipitation. The roof should generally not prevent liquid accessing the sensor from below.

The placement of these sensors will help determine their combined shape, size, and functionality. A large flat area such as the deck of a floating roof may require a two-dimensional array of fluid sensing points spread out evenly or strategically (place only at low points) to detect ‘ponding’. The diameter of the decks may be 10's to 100's of feet. More sensing points across the floating roof deck equates to higher resolution of ponding detection. A floating roof sump may require a single fluid sensing point at a specific elevation in the sump to determine the functionality of the drainage system. A hydrostatic pressure sensor may also be desired in a roof sump to determine the level of liquid backing up.

As detailed in the next section, ponding may also be detected by means of machine vision or lidar. There have been recent advances in lidar using FMCW (frequency modulated continuous wave) technology. For example, SiLC Technologies™ provide a FMCW lidar sensor that has the range to span across the largest diameter tanks, does not interfere with other FMCW lidar sensors, and utilizes polarization intensity which enables identification of surfaces and materials, including water. There is also a version of the FMCW lidar sensor that connects through optical fiber.

### FMCW Lidar Sensors

Until recently, conventional lidar sensors have not been suitable for many applications. They can interfere with each other, have limited range, high power requirements, work poorly on reflective surfaces and different lighting conditions, etc. The advent of FMCW (frequency modulated continuous wave) lidar sensors represents a significant step forward.

Major advancements include ranging precision, direct monitoring of motion through instantaneous velocity, spatial resolution for recognition of fine features and polarization for material detection, reflective surface detection, low power operation, and transmission over optical fiber. As for the applicability of new Lidar sensors to floating roof storage tanks, the sensor(s) can be mounted to the inside upper portion of the shell, looking down on the floating roof. Full vision and coverage are possible with 3 or more sensors.

FIG. 8 shows a perspective view of an embodiment of an external floating roof tank 800, similar to that of FIG. 1a. The lidar system described below could be used in conjunction with the system of FIG. 1a. In this case, the tank comprises an open-topped cylindrical steel container with a shell 809 equipped with a roof 801 that floats on the surface of the stored liquid. In this case, the roof comprises an impermeable roof section and a deformable seal which spans the gap between a rigid (and impermeable) section of the floating roof and the shell 809 to help prevent gas from escaping from the tank. Figure The roof rises and falls with the liquid level in the tank.

In this case, three lidar units 873a-c are mounted to the shell. In this embodiment, the lidar units are spaced apart (e.g., substantially equally) around the top of the shell. This provides a view of substantially the entire surface of the floating roof. Each lidar unit comprises a light transmitter and a light receiver, which communicate with a lidar controller 855a via fiber optic cables 804. This allows the electrical components of the controller to be positioned away from the components of the tank and floating roof being monitored. This may improve safety by reducing the risk of flammable materials being ignited by electrical faults. Each of the three lidar units in this case are directed to monitor the floating roof by emitting light towards the top of the roof. That is, the floating roof is within each of the lidar units' field of flow. It will be appreciated that, in other embodiments, there may be lidar units configured to monitor other components of the tank (e.g., the exterior of the shell).

Lidar sensors and mounting can be applied to both internal floating roofs (IFR's) and external floating roofs (EFR's). The application to IFR's is highly desirable since the inside of the tank is not normally visible without a confined space permit and numerous precautions. There is also equipment present in IFR's that is not required for EFR's such as product roof drains, suspended cables, etc. This additional equipment can be monitored by FMCW Lidar (and fiber optic sensors in certain cases). In additional to equipment there are structural components of IFR's that can be monitored by FMCW Lidar such as the roof. Much like the tanks shell, IFR roofs are susceptible to deformation. A configuration of FMCW Lidar sensors pointed upward from the inside of the tank would be able to monitor such roof deformations. Examples of roofs may be cone, umbrella, geodesic or self-supporting, externally stiffened, fabric, etc.

Sensors can also be mounted in positions to observe the outside of storage tanks. Full vision and coverage of the tank's exterior is possible using 3 or more lidar sensors.

Many parameters of the floating roof can be captured with lidar sensors mounted as described above including one or more of the following:
1. Movement/Velocity of floating roof or portions of floating roof. Product discharge/receipt flow rate can be calculated based on floating roof velocity.
2. Shape of floating roof, both pontoon sections and roof center.
3. Tilt of floating roof.
4. Fill level based on position of floating roof.
5. Movement/Velocity of shell deformations.
6. Shape of the visible portion of tank shell, as seen from the inside of the tank (The visible portion will depend on the level of the floating roof at the time).
7. Movement/Velocity of rolling ladder.
8. Condition of rolling ladder.
9. Condition of the secondary seal and rollover detection.
10. Ponding conditions and the presence of water or tank contents on roof, including sump.
11. Condition and status (open or closed) of access hatches.
12. Presence of personnel or unauthorized person(s).
13. Condition and status of guide pole.
14. Condition and status of gauge hatch & gauge float.
15. Condition and status of vacuum breaker.
16. Condition of visible portion of deck legs.
17. Condition of fixed roof column supports and seals (for IFR's).
18. Condition and status of deck drains (for IFR's).
19. Condition of visible portion of ladder and ladder seal.
20. Deformation of floating roof penetrations such as support columns or gauge poles as a result of the floating roof rotation, tilt, or shell deformation creating contact with a penetration point.
21. Corrosion within line of sight of sensor.
22. Condition of grounding system.
23. Condition of fire suppression system.
24. Fire detection
25. Corrosion
26. Condition and/or deformation of Roof (for IFR's).
27. Shape of the exterior tank shell. This is comparable to tank lidar inspections using current technology except the sensors are permanently mounted and provide real time monitoring of the tank instead of just a snapshot in time. They also monitor any movement/velocity of any pixel of the tank shell.
28. Presence of personnel or unauthorized person(s).
29 Drain valve status (open/closed)
30. Condition of access ladder and gangway.
31. Settlement events (of entire tank or sections of tank).
32. Movement/Velocity of inlet & outlet pipes.
33. Leaks outside of tank.
34. Fires detection.
35. Corrosion on tank exterior.

It can be appreciated that not all detectable conditions are covered in this list. Since the sensing head can detect anything within its line-of-sight to mm level accuracy, monitoring of much more is possible.

A controller may be used to analyze the lidar data which is separate from the controller used to monitor the other fibre optic sensors. It will be appreciated that the controllers may be in communication to correlate the information received from the lidar units and from the fibre optic sensor units.

Current FMCW Lidar systems, such as the “SiLC™ Eyeonic Vision System”, can be configured to only update pixels that show movement/velocity, not static data, thus saving data bandwidth and processing.

FMCW lidar may be configured to allow detection outside the visible spectrum which will permit detection of fuel vapors and temperature.

FMCW lidar units may be configured to communicate with a lidar controller via fiber optic cables.

### Combinations of Sensors

By analyzing and comparing data from different types of sensors, conclusions can be reached relating to the state of the storage tank and/or floating roof.

Often, analysis by the controller of one type of sensor(s) data will provide insight into the root problem causation to a limited degree of probability. When a sensor(s) data of another type is added to the analysis, determination of the root problem causation may increase substantially. As more sensor(s) data is added to the analysis, identification of the root cause may approach certainty. This may be particularly the case when analyzed as a time-series, provided the correct combination of sensor(s) are analyzed under the correct parameters.

The system (e.g., controller and/or remote computer) may be configured to combine data from a range of different sensors to determine a likely cause for the status of the tank as determined by the various sensors. The controller may be configured to present this information to the user or transmit it to a remote computer for presentation. This information can help a user to plan what is required to resolve the situation. For example, if the roof is low because of snow, a different plan is required than if the roof is low because floats are taking on liquid.

Likewise combinations of sensor data may be interpreted by the system to determine a severity of the issue.

The examples provided hereafter help show how additional sensors can help resolve the root cause of the issue detected. The advent of artificial intelligence and machine learning may fully utilize these combinations of sensory data and provide insights independently of human input, adding further value.

### Roof Tilt and Pontoon Pressure Sensors

The controller may be configured to associate a tilt sensor showing an unlevel floating roof and a float having a low pressure with a damaged flotation device. That is, this combination of metrics would be consistent with a deflated floatation device, which would cause buoyancy to be lost from one side of the roof, causing it to tilt.

As described above, a damaged floatation device may also be associated with other flotation devices experiencing an increased pressure.

### Roof Tilt and Pontoon Liquid

The controller may be configured to associate one or more float or pontoon liquid sensors with one or more roof tilt sensors. These two metrics analyzed together over time will provide a more definitive conclusion to the state of the floating roof.

For example, if the presence of liquid is detected in one or more pontoons or floats and one or more roof tilt sensors begin to show signs of increasing roof tilt angle in the direction of the compromised pontoons, the controller may identify that the compromised pontoons are causing the roof tilt. The likelihood of liquid filled pontoon causation increases if the sensors can measure the amount of liquid within the pontoon, as in the multiple discreet sensors at different elevations or analog sensors that measure hydrostatic pressure. For example, periods of increased pontoon liquid volume coincide with increased tilt angle. In this case, the combination of sensors allows the cause of the issue to be determined by the controller (e.g., the engineer may be informed that they need to repair or replace the faulty pontoons), and the severity of the issue (e.g., if the tilt is within operational range and stable may be a lower priority than if the tilt is exceeding operational range and unstable).

Alternatively, a floating roof may become tilted due to reasons such as snow/rain loading or shell deformation induced hang-up (e.g., where the floating roof becomes stuck with respect to the shell and no longer moves up and down with the stored product liquid level) and cause unpressurized pontoons to fill with liquid due to the submersion of a section of a roof in the tank's contents, causing the pontoon liquid sensors to activate. The snow/rain loading is detectable by ponding sensors and/or FMCW lidar. The deformation induced hang-up is detectable by vibration analysis and/or seal sensors and/or FMCW lidar. Furthermore, to this example, a rolling ladder may become damaged during the excessive roof tilting which would be detectable by the rolling ladder tilt sensor and/or FMCW lidar. A remote operator would benefit from having all the situational data; not only is the floating roof excessively tilted, but also product is leaking into the pontoons, and access via the rolling ladder is unsafe due to structural damage.

### Shoe Seal Displacement Sensors and Tilt Sensors

The central controller may be configured to analyse and compare data from the shoe seal displacement sensors. For example, if the shoe seal displacement sensors are all showing minimum displacement on one side of the tank (i.e., with the shoe seal being closer to the centre of the roof), the roof may be tilted downwards and applying more pressure towards those sensors.

The show seal displacement sensors on the upwards side of the floating roof may be showing maximum displacement from the tank shell (i.e., with the shoe seal extended away from the centre of the roof). This combined information helps analyze the cause of the malfunction.

Combining this with the vibration (a secondary frequency metric) of the shoe displacement sensors, the central controller may be configured to determine that the shoe seal is not touching the shell at the upwards end of the floating roof and the downward end vibration has changed to be in the aggressive contact category.

This acts as a redundant measurement to help verify tilt.

In addition, as described above, measuring at different locations across the roof section surface allows the deformation of the roof section to be determined. Using the extension of the displacement sensors on the shoes may also be used by the controller to constrain what kinds of deformation is consistent with both the tilt measurements and the displacements measurements.

### Roof Tilt Sensor and Pontoon Liquid and Shoe Seal Displacement

The controller may be configured to associate one or more annular pontoon's liquid sensors with one or more tilt sensors in addition to one or more shoe seal displacement sensors. These three metrics analyzed together over time will provide a more definitive conclusion to the status of the floating roof. For example, if the presence of liquid is detected in one or more pontoons and one or more tilt sensors begin to show signs of increasing roof tilt in the direction of the compromised pontoons while shoe seal displacement sensors indicate increased strain close to the liquid filled pontoon(s), the causation of the roof tilt becomes even more evident than observing just one or two types of sensors. The likelihood of liquid filled pontoon causation increases if the sensors can measure the amount of liquid within the pontoon, as in the multiple discreet sensors at different elevations or analog sensors that measure hydrostatic pressure. For example, periods of increased pontoon liquid volume coincide with increased tilt angle and increased strain on the shoe seal displacement sensors close to the liquid filled pontoon(s). The shoe seal displacement sensors on the opposite side of the tank may indicate decreased strain during these periods, which would indicate a general shifting or imbalance of the entire floating roof.

### Shoe Displacement Sensor Array

As described above, the seal may comprise a series of abutting shoes arranged around the perimeter of the tank.

As described above, FIG. 1b shows one embodiment of how the shoe may be attached to the roof. FIG. 5 shows an alternative embodiment with multiple displacement sensors. As before, each shoe is a plate which is disposed against the inner wall of the tank shell (not shown), and which is mechanically connected to the outer rim of the floating roof section (not shown). In the embodiment of FIG. 5, the mechanism connecting the shoe to the roof section comprises a linkage mechanism 526a-c (in this case an articulated arm also known as a scissor hanger assembly) and a resilient portion, such as a spring, plate, or bar for biasing the shoe 523a-c away from the roof section and towards the inner wall of the tank shell.

In this embodiment, there are two types of resilient portions: compression bars 517a,b and compression plates 512a,b. Both compression bars and compression plates comprise a sheet of resilient material. The resilient sheets, in this case, are affixed to the roof portion at a proximal end, and are configured to abut the inner surface of the shoe 523a-c at a distal end. As the shoe moves in and out with respect to the roof portion, the resilient sheets accommodate the change by bending and the distal end of the sheet slides across the surface of the shoe. The distal end of the sheets may be curved to facilitate sliding. The resilient sheets are configured to apply a significant biasing force on the shoe away from the roof portion to help ensure that the shoe maintains a good contact with the shell. It will be appreciated that the biasing force is generated from the bending deformation of the resilient sheet. It will be appreciated that the resilient sheets span the gap between the roof section and the shoe plate at an angle. That is, the axis of deformation of the resilient sheet to provide the biasing force is in the plane of the resilient sheet.

In this embodiment, the compression bars are arranged in pairs, each pair extending laterally and symmetrically outward from a common axis at the proximal ends. The distal ends are spaced apart and both connect to the same shoe. In contrast, each compression sheet in this case is configured to span across the seam between two shoes. This helps ensure that the shoes stay connected at the edge, but it does mean that it may be more difficult to isolate information on a particular shoe from data derived from a compression sheet. It will be appreciated that other configurations may be used in other embodiments. For example, each shoe may have a pair of compression plates (e.g., one at each side) or a single compression plate arranged centrally. Another embodiment may have two sets of compression bars (e.g., one pair at the top and one pair at the bottom).

In this embodiment, a strain sensor 514a-b, 518a-b is affixed to the surface of the resilient sheets such that as the resilient sheet bends, the strain of the resilient sheet can be measured by the strain sensor. The strain sensor in this case comprises a Fibre Bragg Grating cables (e.g., comprising a pair of fibre optic cables configured to measure the bending strain along the length of the resilient sheet). That is a displacement sensor may be considered to be the combination of a strain sensor with the resilient sheet. In this case, the axis of the strain sensor is aligned with an elongate axis of the resilient sheet. That is, the strain sensor is aligned with an axis passing between the point at which the resilient sheet is attached to the roof portion, and the point at which the resilient sheet is connected with the shoe.

In this case, the distal end of each compression plate is towards the bottom of the shoe, and the distal end of each compression bar is towards the top of the shoe. By monitoring the displacement of the top and bottom of the shoe independently, both the distance of the shoe from the roof, and the relative tilt of the shoe with respect to the roof can be measured. As shown in FIG. 5, the compression bars are oriented horizontally (i.e. with the proximal and distal ends of the bar being at the same height) and the compression plates are arranged vertically (i.e. with the proximal and distal ends of the plate being at different heights). It will be appreciated that other orientations are possible.

In this case, the sensors are linked in series to a single fibre optic line. This means that the interrogator can distinguish and identify each strain sensor using the time it takes for light to come from the source, reach the strain sensor Bragg grating, and return to the interrogator.

As a further use, fiber optic displacement sensors are known to be very sensitive to vibrations (a frequency metric). A dynamic floating roof produces various vibratory signatures as it travels. A primary and/or secondary seal may produce obvious vibratory signatures since these are the mediums by which the floating roof makes contact with the tank shell. The displacement sensors may be located close to these points of contact (i.e., seals). Vibrations sensed by the displacement sensor (and possibly other sensors) can distinguish between a seal making aggressive contact, normal contact, light contact, or no contact at all. The controller may be configured to categorise the strength of contact based on the characteristics of the vibration detected by the displacement sensor (e.g., frequency, amplitude). Again, by measuring the differences between the vibration at the top and at the bottom of the shoe, the system may be configured to identify where the strongest contact between the shoe and the shell is being made.

In this embodiment, there are also other flexible components which are configured to connect between the roof section and the shoe. In this case, a series of support straps 519a are used to support the upper sealing canvas. These support straps are somewhat resilient, in that they have a consistent shape for a particular shell-roof spacing, but they are not, in this case, configured to apply a significant biasing force between the roof section and the shoe. In other embodiment, strain sensors may be applied to this support strap to measure strain, displacement and/or vibration frequency.

### Chemical Sensors and Shoe Displacement Sensors

As shown in FIG. 1b, the shoe mechanism forms an enclosed cavity with the upper wiper seal.

Detection of chemical within the tank within this cavity indicates that the lower part of the seal may not be working properly. Combining this information with information from the shoe displacement seal may allow the operator to diagnose the problem before sending someone to inspect the damage.

For example, detecting an increase of chemical within this enclosed cavity while the data from the shoe seal is otherwise normal, may indicate damage in the lower wiper seal.

In contrast, if an increase of a chemical is detected within this cavity and this is associate with the shoe being retracted (e.g., determined based on the extension of the displacement sensor) and/or the shoe making light or no contact with the shell (e.g., based on the vibration signature), then the controller may be configured to identify that the shoe connecting mechanism has broken (e.g. the resilient biasing member has failed or the lever mechanism has seized).

This would allow the operator to gather the supplies necessary for repair prior to opening the seal structure.

### Chemical Sensors and Shoe Displacement Sensors and Tilt Sensors

Adding tilt sensor data to chemical sensor and shoe displacement sensor data helps determine the root cause failure with greater certainty. A severely tilted roof would activate chemical sensor(s) located in the enclosed cavity on the downward end of the tilt. Combine these metrics with a shoe making heavy contact on the downward end & light contact on the upward end for added data value.

### Tilting Structure Tilt Sensor and Depth Sensor

As described above, mounting a tilt sensor on a tilting structure between the roof and the shell provides one measure for the depth of liquid in the tank. The depth sensor provides a different method of measuring the same parameter.

Measuring the same parameter in multiple different ways may allow the controller to determine other information. For example, if the roof level goes down (determined by the tilt sensor) but the depth sensor indicates that the weight of the liquid is the same, this may be associated by the controller with floats losing buoyancy.

Alternatively, if the weight of liquid is changing but the height of the roof is not, this the system may determine that the roof is resting on legs or other roof supports or may be hung up on a shell deformation. The controller may be configured to monitor the roof height when the roof is resting on legs to determine if the height of the roof when standing on supports is consistent. Inconsistencies may arise from damage to the roof supports, sediment in the bottom of the tank or subsidence of the tank bottom. This measurement is only possible by measuring the height of the roof independently from the depth of liquid in the tank.

### Wiper Tip Vibration Sensor Array

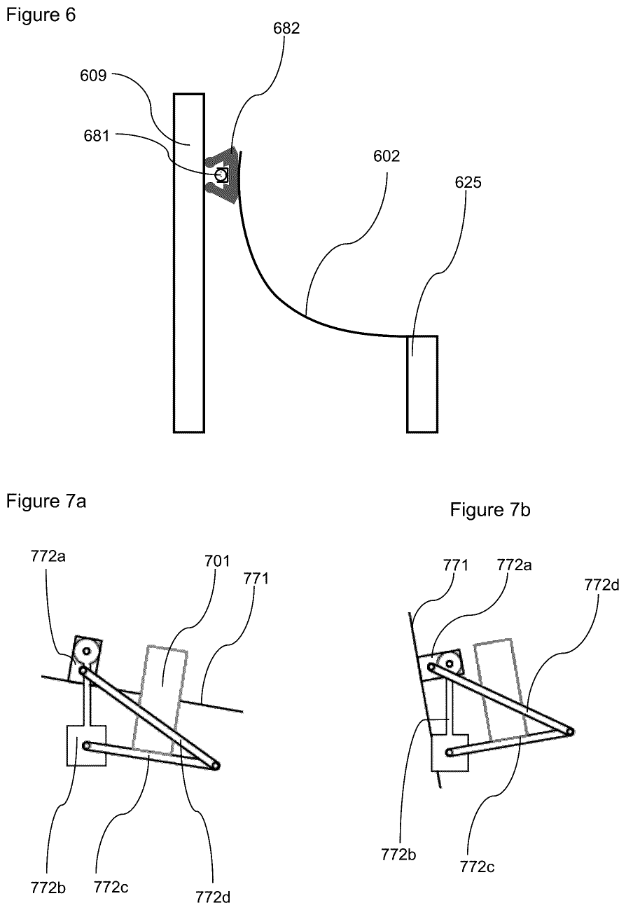

FIG. 6 shows a simplified cross section of a wiper seal assembly which is configured to span between the impermeable roof section 625 of a floating roof and the container shell 609. In this case, the wiper seal assembly comprises an impermeable canvas 602, support members (not shown), and a wiper tip 682.

The impermeable canvas 602 is configured to prevent gas from passing up from the container and into the atmosphere. The impermeable canvas is supported on a series of support members which, in this case, comprise resilient metal arms. The support members are also configured to hold the wiper tip and provide a biasing force to hold the wiper tip against the container shell 609.

In this case, the wiper tip 682 is formed from extruded rubber and is configured to extend around the perimeter or circumference on the inside of the shell 609. The cross section of wiper tip 682 is in the form of an open channel in the form of a C, with an upper contact point and a lower contact point with the shell. In this case, there is a fibre optic cable attached to the wiper tip (in this case via a metallic C-channel). In other embodiments, the fibre optic cable may be attached directly to the wiper tip rubber. The fibre optic cable is housed within the channel between the upper and lower contact points.

The fiber optic cable 681 in this case includes Fibre Bragg Gratings which are sensitive to strain. The controller in this case is configured to determine whether the Fibre Bragg Gratings are vibrating. If vibrations are detected for some parts of the wiper tip, but not others, the controller may be configured to identify that the non-vibrating locations have detached from the shell (i.e., forming a gap through which gas can flow). The controller may be configured to identify non-vibrating portions in response to vibrations being detected elsewhere along the wiper tip. These vibrations may be induced by the roof moving up and down and/or an external force being applied to the tank (e.g., by the wind). The controller may be configured to identify non-vibrating portions in the wiper tip in response to the roof moving up and down (e.g., based on a sensor measurement of the fluid level in the tank changing and/or the height of the roof changing). This may be a relatively inexpensive way of monitoring the contact between the wiper tip and the shell.

In this case, the fibre optic cable is a single line with fibre Bragg gratings positioned along the length of the cable. Each portion of fibre Bragg grating may be considered to be a separate vibration sensor. This arrangement is primarily configured to measure vibrations. It will be appreciated that other embodiments may comprise multiple fibre optic lines with paired fibre Bragg gratings to measure deformation. Other embodiments may comprise fiber optic lines coupled with vapor detecting materials.

### Lidar Sensor Captured Condition Combinations

Some of the captured conditions collected from lidar sensors work well together in tandem (i.e., Solely using Lidar sensory data). Some examples may include:

The velocity of the floating roof should always correlate with the velocity of the rolling ladder. If the roof is moving but the ladder is not, an event alert can be triggered by the controller.

The shape of the “visible portion of the inner tank shell” and/or “entire portion of the outer tank shell” can be monitored for movement/velocity along with the position/velocity of the floating roof. The deformation of the tank shell sections can be correlated with the total product volume or product receipt/discharge flow rate. When shell deformations are monitored over time, analytical algorithms can calculate increased probability of stress induced failures around the areas that cycle the most and/or have the greatest degree of movement. It can be appreciated that stress failure analysis may be applied to any location where deformation is detectable.

The “visible portion of the inner tank shell” and/or “entire portion of the outer tank shell” can be monitored for movement/velocity along with the position/velocity of secondary seal. An abrupt change or rollover in the secondary seal may occur at the same location as a tank shell depression.

### Lidar Sensor and Other Fiber Optic Sensor Combinations

The controller may be configured to associate one or more Lidar sensor with one or more fiber optic sensor. Although lidar sensors have a greater range of visibility than the fiber optic sensors discussed here, they have limitations. Therefore, the combination of lidar and fiber optic sensors creates an added value far beyond the individual benefits of either method. Fiber optic sensors such as pontoon liquid, primary seal shape, settlement, tank floor liquid, foundation drain liquid, ground-water porosity/permeability, vibration, temperature, chemical sensing, and shoe seal displacement are well suited to sense conditions that are not visible to inspectors, cameras, or lidar. Cameras & lidar are better suited for large open areas. The intrinsically safe properties of the fiber optic sensors allow them to come into direct contact with liquid fuels and vapors where cameras and other sensors cannot. There are also certain metrics that fiber optic sensors can measure that remain out of reach for the current lidar or camera sensors (e.g., temperature or pressure).

### Lidar Sensor & Fiber Optic Sensor Combinations (Tank Shell)

The visible portion of the inner tank shell and/or entire portion of the outer tank shell may be monitored for movement/velocity along with tank settlement data. This settlement data may come in the form of fiber optic shape/strain sensors affixed to the tanks exterior base or foundation, fiber optic ground water porosity sensors, or the secondary vibrational data collected from any of the other sensors in operation that can collectively register a movement in the tank's foundation.

The shape of the visible portion of the inner tank shell and/or entire portion of the outer tank shell may be monitored for movement/velocity along with the displacement of the shoe seals. An abrupt change in displacement may occur at the same location as a tank shell depression.

The shape of the visible portion of the inner tank shell and/or entire portion of the outer tank shell may be monitored for movement/velocity along with the primary seal shape. An abrupt change in the shape of the primary seal may occur at the same location as a tank shell depression.

The shape of the visible portion of the inner tank shell and/or entire portion of the outer tank shell may be monitored for movement/velocity along with the chemical sensing within the enclosed rim space. Detection of chemicals may occur at the same location as an outward tank shell protrusion which allows chemical vapors to leak past the primary seal.

The shape of the visible portion of the inner tank shell and/or entire portion of the outer tank shell may be monitored for movement/velocity along with primary and/or secondary seal vibration data. A noticeable difference in the vibration signatures collected from the primary and/or secondary seals may occur at the same location as a tank shell depression or protrusion. An inward depression may change the vibratory signature to increase in amplitude or change frequency since the seal is contacting the shell more aggressively. An outward protrusion may change the vibratory signature to decrease in amplitude or change frequency since the seal would barely contact the shell or not at all.

The shape of the visible portion of the inner tank shell and/or entire portion of the outer tank shell may be monitored for movement/velocity along with the movement/velocity of the secondary seal. As the secondary seal moves up & down along the inner tank shell, it's movement/velocity may be correlated with depressions/protrusions of the tank shell. A rollover condition may occur at an area of shell depression. An event alert may be triggered when a rollover condition is imminent. Alternatively, a gap in the secondary seal may be detectable by FMCW lidar at an area of shell protrusion. Between detecting gap & rollover conditions of the secondary seal, a very high degree of value is added.

The shape of the visible portion of the inner tank shell and/or entire portion of the outer tank shell may be monitored for movement/velocity along with the shape of the primary seal. As the primary seal moves up & down along the inner tank shell, it's shape may be correlated with depressions/protrusions of the tank shell detected by FMCW Lidar.

It can be appreciated that the any and/or all the sensing functions mentioned in the section “Lidar Sensor & Fiber Optic Sensor Combinations (Tank Shell)” may be combined for the identification of root problem causation. For example, there may be a foundational event alert detected by FMCW lidar that references half the tanks foundation and draws attention to various detectable conditions; ground-water porosity, primary seal gap, secondary seal gap, vibration around the half of tanks rim space, and chemical detection. Analyzing all these conditions together in a time-series application may detect the ground water porosity increasing steadily until the foundation & vibration event occurs, followed shortly after by primary & secondary seal gap and a chemical sensor activation. Combinations similar to this example are possible and too numerous to all be listed within the scope of this patent.

### Lidar Sensor & Fiber Optic Sensor Combinations (Floating Roof)

The shape of the floating roof can be monitored for movement/velocity along with pontoon fiber optic liquid sensors. Pontoon(s) that fill with liquid will likely affect the shape & position of a floating roof. The more liquid that fills the pontoon(s), the greater the deformation or position change.

The shape and/or position of the floating roof can be monitored for movement/velocity & position along with ponding fiber optic sensors. The ponding of a floating roof can cause tilt, deformation, or loss of buoyancy depending on the location and depth of the ponding. Evenly distributed loading of the roof can cause it to lower in position. Unevenly distributed loading can cause deformation or tilt of the roof, such as heavy ponding on opposite sides or just one side. Current FMCW lidar technology claim to detect and differentiate between transparent materials such as ice and glass through polarization detection. Water also falls into this category, in which case, fiber optic ponding sensors would be redundant. If lidar cannot detect ponded water efficiently, then fiber optic ponding sensors would prove to be an important contribution to floating roof shape/position sensing. Fiber optic ponding sensors would verify the floating roof deformation depending on the detected location and perhaps depth of the water. If ponding sensors capable of hydrostatic pressure sensing are used, then the depth of the ponded water would be an important metric to verify the causation of the floating roof deformation.

The shape and/or position of the floating roof can be monitored for movement/velocity & position along with fiber optic tilt sensors. In this scenario, the fiber optic tilt sensors provide certainty that the lidar is detecting the correct floating roof shape. Roof tilt is such a vital safety & operational feature of a floating roof storage tank that verifying lidar data with a hardwired physical sensor(s) can only help ensure safe operation.

The floating roof can be monitored for velocity along with flow sensors that monitor the discharge/receipt of product. These flow sensors may already be part of the tanks distributed control system and are not necessarily part of the fiber optic sensing system proposed in this patent (Although there is no reason that fiber optic flow sensors cannot be used). Flow sensors provide operators with the means to calculate total volume in addition to flow rate. Verifying the velocity of the floating roof against the flow sensor values, and the position of the floating roof against the calculated volume, can provide an additional layer of certainty that the correct tank is receiving/discharging product at the expected rate. This visual verification is a feature appreciated by operators and provides a level of comfort and certainty that mistakes were not made. In addition, the redundancy offered by this combination, helps verify the correct operation of either sensor. For example, if a floating roof velocity is detected by lidar but the flow meter is reading a different value or no value, then the flow meter may need calibration or troubleshooting. It can be appreciated that since FMCW lidar can inherently detect an objects velocity by comparing the distance of any pixel over time, then the velocity of the floating roof is detectable and the receipt/discharge flow rate may be calculated as a secondary function of this velocity.

The floating roof can be monitored for position along with fiber optic pressure sensors used to detect liquid fill level. The liquid fill level of a floating roof storage tank is a one of the most important metrics to be aware of and is regulated under API 2350. Overfilling floating roof storage tanks has led to catastrophic results, including fire, explosion, environmental damage, loss of life, heavy fines, lost production, etc. There are various sensors that can infer liquid levels including the Emerson Rosemount series radar sensors, but there are disadvantages to using these systems including high cost, required redundancy, additional hardware, not intrinsically safe, and indirect measurement of tanks contents.

A fiber optic hydrostatic pressure sensor is very well suited for this application. Verifying the position of the floating roof using lidar against the liquid level sensor values, can provide an additional layer of certainty that the tank liquid level is correct and will not be overfilled. This combination offers complimentary data rather than redundancy since the hydrostatic pressure sensor measures the tank contents height and the FMCW lidar measures the height of the floating roof. These two values may vary depending on factors listed previously in this patent.

Having additional modes of measurement is beneficial if a floating roof high level is detected by lidar but the liquid level sensor is reading a different value or no value, then the liquid level sensor may need calibration or troubleshooting.

It is also undesirable to remove too much product from the tank which can create a vapor space when the floating roof lands on the deck legs. Floating roof shape can be monitored by the lidar sensors when the roof/deck legs hit bottom, analyzing velocity/movement of the deck sheathing. The state of the deck legs can be analyzed by this movement. For example, analyzing which deck legs hit the bottom first, which hit last, or which have no effect on the deck. This analysis could help understand the evenness of the tank bottom as it relates to the shape of the floating roof. This analysis could also indicate the buildup of sludge on the bottom of the tank. This bottoming out could also be registered by the secondary vibration function of the floating roof fiber optic sensors such as the ponding sensors. A metal-on-metal (deck leg(s) on tank bottom) signature would induce a different vibration signature than a metal-sludge-metal signature.

This multiple sensor approach can also be a safeguard against leaking tanks. If the flow sensor has not detected flow for a certain time and the floating roof has lowered in elevation, this could be an indication that a leak is present. It could also mean that the floating roof is losing buoyancy, but the presence of pontoon liquid sensors and roof ponding sensors can eliminate this from the equation, leaving only the possibility of a leaking tank. A software algorithm can be applied to trigger an event based on these conditions. Without the combination of these sensors, a tank could leak a substantial amount of product before detection.

The floating roof can be monitored for velocity along with a fiber optic tilt sensor located on the rolling ladder. Granted, the condition and movement of the rolling ladder can also be monitored with the lidar sensors, but a having a physical hardwired tilt sensor on the ladder ensures backup and redundancy. Not just for the rolling ladder but for the motion of the floating roof. For example, if the lidar sensor does not register movement of the floating roof but the tilt sensor is registering motion of the rolling ladder, then there may be a problem with the lidar system.

It can be appreciated that the any and/or all the sensing functions mentioned in the section “Lidar Sensor & Fiber Optic Sensor Combinations (Floating Roof)” may be combined for the identification of root problem causation. For example, a snowstorm event occurs causing an accumulation of snow on the north side of a floating roof tank and the roof increasingly tilts towards the north side as the snow accumulates. The FMCW lidar detects the accumulation of snow but detecting the exact tilt may be more difficult since the floating roof deck is now obscured. However, the tilt sensor can accurately detect the increased tilt. As the roof continues to tilt, ponding sensors on the north side of the roof are activated due to the snow melting and water accumulating on the north end. Concurrently, several pontoon liquid sensors have now activated due to a weld fractures caused by the floating roof deformation stresses. Combinations similar to this example are possible and too numerous to all be listed within the scope of this patent.

It can be appreciated that the any and/or all the sensing functions mentioned in this patent may be combined for the identification of root problem causation. It would be unrealistic to explain all combinations and scenarios.

### Other Considerations

Floating roof shape sensing may be achieved by means of combining sensors (e.g., a series of tilt sensor positioned across the floating roof).

Floating roof shape sensing may be achieved by means of adding a Fiber Optic distributed sensor array that may or may not include Fiber Optic FBG's to the floating roof.

Floating Roof floatation devices or mechanisms such as pontoons and their associated strain sensor(s) may be used and/or combined to capture floating roof shape status.

The use of floating roof sensor(s) may detect the presence of excessive temperature change, risk of fire or fire. That is, the strain and/or displacement sensor(s) may detect temperature changes, the pontoon air pressure may change as a result of temperature or various combinations thereof.

When the data from these combined sensors is compared against the tank shell deformations, troubleshooting can be greatly enhanced by understanding the relationship between tank shell deformations and the effects it has on the floating roof.

By understanding data provided by floating roof sensors, we can understand where/when/why shell deformations are happening. For example, by analyzing the liquid level one can correlate shell deformations that happen at specific liquid levels that would not otherwise be apparent, or a tilted roof may apply extra force to one side of tank, accelerating a deformation, or a deformation may prevent a roof from travelling freely causing a tilt.

The one or more fiber optic sensors may have an inclusive secondary temperature detection function in additional to their primary function. Many fiber optic sensors are very susceptible to changes in temperature and thereby require redundant sensors (temperature compensation) within proximity to eliminate temperature as a factor from their primary measurement (e.g., Sensor A measures strain and temperature, Sensor B measures just temperature, therefore subtract B from A to eliminate temperature. The difference is temperature, and the result is strain).

This sensitivity to temperature can be seen as a benefit. A tank equipped with many fiber optic sensors essentially becomes a distributed temperature sensor system. Data from this system can prove to be very valuable for detecting effects from sun, storms, weather events, lightning strikes, and fires to the distribution of temperature created from normal operations. Equipment (e.g., generators) are purposely fitted with numerous RTD probes (resistive thermal devices) to understand the distributed temperature of the equipment. The system of fiber optic sensors proposed in this patent inherently contains this system. Anywhere a fiber optic sensor is placed along with temperature compensation, the ambient or surface temperature will be known. If no FBG mechanical coupling is implemented then fiber optic sensors can also be placed specifically for the purpose of temperature sensing such as the inside of a tank (e.g., walls, floors, & ceiling) to directly measure the temperature of the fluid throughout its operational cycle. The product stored in many of these storage tanks have critical temperature thresholds. Those temperatures may be controlled using heating or cooling equipment. The temperature of the product may be known at that point but becomes unknown as it travels throughout the system. Owner/operators would benefit in knowing that the product has always remained within the temperature threshold.

Ground water porosity/permeability sensors are an excellent candidate for sensor combinations. Knowing the ground water saturation by itself is only partially helpful but combine this data with FMCW lidar sensors observing the exterior of a tank shell and the value added becomes apparent. For example, a FMCW lidar sensor may see a 1 cm downward shift along one side of tank shell and a porosity sensor may see a 50% increase in ground water saturation concurrently, as the tide is at the high-tide level. Add the vibration signatures from one or more floating roof sensors into this equation, and the degree of causation increases significantly. An example of a pore water pressure sensor may be the Technicasa T620.

The role of storage tank operators, engineers, and management would be greatly enhanced by the data provided by combined sensor capabilities. The information from a combined sensor configuration can be displayed through historian software. This would provide the ability to view time-based information in a highly customized software environment and allows for root causes to be diagnosed in a way that was previously impossible.

The amount and variety of sensors proposed, will lend itself to applications in AI (artificial intelligence) and ML (machine learning). These advanced algorithms may detect anomalies long before hard-coded algorithms or operators could. Time-Series databases (i.e., TimescaleDB) will help facilitate the connection between these sensors and AI/ML algorithms.

The amount and variety of sensors proposed, will lend itself to VR/AR/XR (virtual, augmented, mixed reality) technologies and help greatly enhance the ability of operators, engineers, inspectors, and management to visualize the data collected. For example, using an augmented or mixed reality headset out in the field, and inspector could see the color map of a tank shell superimposed onto the real shell and understand in real time exactly where the deformations are happening.

### Other Options

Single or Multi-phase Fiber Optics cables may be applied to the Storage Tank Floating Roof Seal, Rim Space components and spacing around floating roof penetrations such as columns and gauge poles. Distributed fiber-optic sensing arrangement may utilize the Fiber Bragg Grating (FBG) as well as the Distributed chemical sensing (DCS).

The apparatus may be configured to allow distributed chemical sensing based on the spatially resolved interaction of the light with the fiber optic cable.

The apparatus may be configured to automatically detect deformation while the tank is being filled or liquid is being removed from the tank. For example, the apparatus may be turned on when a tank inlet or outlet is opened. Sampling and data-processing may also be increased during receipt or discharge of liquid.

The apparatus may comprise one or more fiber optic sensor attached on the floor of the tank or between the epoxy layer and the structural layer to detect the presence of liquids. This would provide an early notification of compromised tank flooring and may prevent major leaks before occurring.

The apparatus may comprise one or more fiber optic sensor attached within the foundations drains to detect the presence of liquid (either liquid escaping the tank through the floor or liquid entering the foundation from the environment). If a rupture has occurred in the tanks flooring and/or foundation, drainage sensors can be used to improve the response time.

The apparatus may comprise a deformation fiber-optic cable sensor attached along its length to the outside of the container shell. For example, this fiber-optic cable sensor may be positioned on or adjacent to a weld and/or towards the bottom of the tank. This may allow settling of the tank to be measured more directly. The fiber-optic cable may be installed by means of a fiber optic laying, remotely operated, magnetic crawler-type robot.

This apparatus may be used to alert the owner operator or, other user, of potential damage to internal assets prior to code compliance inspections, allowing for accurate repair plans and material purchasing. Being prepared for more extensive cleaning of the confined space for personnel to enter and perform work.

This apparatus may be used in conjunction with third party software and/or proprietary software.

This apparatus may be used to know whether trapped gases or liquid hydrocarbons are present inside the floating roof pontoons, while Tanks are in-service. To proactively monitor any breach/leak in floating roof pontoons, compliance of shoe seals, all fabrics relative to emissions.

This apparatus may be used to know whether product has leaked, penetrated or saturated any part of the floating roof and or component/surface not designed to be in contact with product. This includes regulatory spaces governed by emissions or safety regulatory controls. This may include components such as internal pontoons spaces, floating hexagon or honeycomb designs, double deck styles.

This apparatus may be used to know whether product has leaked, penetrated or saturated any part of the foundation not designed to be in contact with product. This includes regulatory spaces governed by emissions or safety regulatory controls. This may include components such as floor cavities, foundational drains, wells, or berms.

This apparatus may be used to monitor and detect the atmospheric side, topside of the floating roof by way of Opto-Acoustic Distributed Sensing System (DSS) sometimes referred to “Outside-the-Cladding” Fiber Optic Sensing:

This apparatus may be used to detect the presence and location of water that may collect on the surface and be impeded by insufficient or faulty drainage. This anomaly is a major cause of the floating roof “Ponding”, malfunction, emissions, seal and roof damages. This apparatus may be used to perform one or more of the following:
monitor the status of floating roof during major weather events.
To detect the presence and location of the product on the topside of the floating roof.
To detect the presence and movement: example: of people in regard to permits, safety and working alone procedures and policies.
To detect the presence of non-permanent equipment, materials or supplies
To detect the presence of fire or excessive heat.
To detect weather/man-made related debris effecting drainage ability, excessive weight or uneven distribution of weight.

This apparatus may be used to monitor and detect the product or bottom side of the floating roof by way of Opto-Acoustic Distributed Sensing System (DSS) sometimes referred to “Outside-the-Cladding” Fiber Optic Sensing. Opto-Acoustic Sensors may be affixed to the underside of the floating roof for monitoring or detecting the following:
Structural status of storage tanks floor or bottom plates-Specifically, any Edge settlement, plate depression, plate buckling or bulges.
to detect undesired changes in the product or quality
the presence and scope to which water (Within Fuel)
including sediment or sludge material concentration or build-up
determining or mapping the volume of solid material buildup

This system may be used to monitor or detect the presence of fire, or temperature variations, by means of one or more sensing technologies as described above.

Although the present invention has been described and illustrated with respect to preferred embodiments and preferred uses thereof, it is not to be so limited since modifications and changes can be made therein which are within the full, intended scope of the invention as understood by those skilled in the art.

### REFERENCES

(1) Pouyakian, M et al. “A comprehensive approach to analyze the risk of floating roof storage tanks”, Process Safety and Environmental Protection, Volume 146, (2021), Pages 811-836
(2) “Victoria-based Syscor's FR-Tracker system acts as a wireless watchdog for floating tank roofs”, Blogpost Published online: May 10, 2018, https://www.enbridge.com/Stories/2018/May/Syscor-floating-tank-roof-wireless-monitoring-crude-oil-storage
(3) Lu, X et al. “A Review of Methods for Fibre-Optic Distributed Chemical Sensing” Sensors 2019, 19, 2876

1. A floating-roof tank assembly comprising:
a floating roof having:
an impermeable roof section;
a floating-roof seal configured to span between the impermeable roof section and one or more walls of a container of a floating roof tank;
one or more floats attached to the roof section;
a sensor assembly comprising:
a fiber optic sensor array comprising one or more fiber optic sensors;
a light source configured to transmit light to the one or more fiber optic sensors;
a receiver configured to detect light from each fiber optic sensor; and
a controller configured to process the light received by the receiver to determine the status of the floating roof tank.

2. The floating-roof tank assembly according to claim 1, wherein the one or more fiber optic sensors comprises a float pressure sensor, the float pressure sensor comprising a fibre optic cable portion configured to detect strain in one or more of the deformable floats, and wherein the controller is configured to determine a pressure of the deformable float based on the detected strain.

3. (canceled)

4. The floating-roof tank assembly according to claim 1, wherein the controller is configured to monitor the pressure of the deformable float over time to identify leaks in the deformable float, and wherein the controller is configured to identify different leak types based on the rate of change of pressure monitored over time.

5. The floating-roof tank assembly according to claim 1, wherein the controller is configured to identify whether the leak is in contact with a liquid or a gas based on characteristic frequency components within the determined pressure readings over a period of time.

6. The floating-roof tank assembly according to claim 1, wherein the controller is configured to correlate the monitored pressure of multiple deformable floats.

7. (canceled)

8. (canceled)

9. The floating-roof tank assembly according to claim 2, wherein the float pressure sensor comprises a deformable diaphragm which is connected to a said float such that one side of the diaphragm is in contact with the gas inside the float, and an opposite side of the diaphragm is in contact with the atmosphere.

10. The floating-roof tank assembly according to claim 1, wherein the one or more fiber optic sensors comprises a liquid level pressure sensor positioned at the bottom of the tank, the liquid level pressure sensor comprising a gas-filled sealed deformable vessel and a strain sensor configured to determine the deformation of the sealed deformable vessel, and wherein the controller is configured to determine the liquid level based on the pressure determined by the liquid level pressure sensor.

11. (canceled)

12. The floating-roof tank assembly according to claim 1, wherein the fibre optic sensor array comprises multiple tilt sensors mounted at different positions on the impermeable roof section, and wherein the controller is configured to determine deformation of the impermeable roof section based on the different tilts of the roof measured at the different positions.

13. The floating-roof tank assembly according to claim 1, wherein the one or more fiber optic sensors comprises a displacement sensor connected between the roof section and a shoe of the floating-roof seal, the displacement sensor being configured to determine the movement of the floating-roof seal with respect to the impermeable roof section.

14. (canceled)

15. (canceled)

16. The floating-roof tank assembly according to claim 1, wherein the fibre optic sensor array comprises a float liquid detection sensor positioned inside one of the floats, the float liquid detection sensor configured to detect the presence of one or more of: a liquid stored in the container and water.

17. The floating-roof tank assembly according to claim 1, wherein the fibre optic sensor array comprises a float vapor detection sensor positioned inside one of the floats, the float vapor detection sensor configured to detect the presence of one or more of: hydrocarbon vapor, volatile organic compounds and solvent.

18. The floating-roof tank assembly according to claim 1, wherein the fibre optic sensor array comprises a roof liquid detection sensor positioned on top of the floating roof, the roof liquid detection sensor configured to detect the presence of one or more of: a liquid stored in the container and water.

19. (canceled)

20. (canceled)

21. The floating-roof tank assembly according to claim 1, wherein the floating-roof tank assembly comprises a plurality of frequency modulated continuous wave roof lidar units configured to monitor the position of the floating roof, and wherein the roof lidar units are configured to measure the polarization of the received light.

22. The floating-roof tank assembly according to claim 1, wherein the sensor assembly comprises a ladder sensor configured to monitor the position of a floating ladder spanning between the container with the floating roof and wherein the floating-roof tank assembly comprises a plurality of frequency modulated continuous wave roof lidar units configured to monitor the position of the floating roof, and wherein the roof lidar units are configured to monitor the position of the floating roof, wherein the controller is configured to trigger an alert in response to the position of the floating roof changing without a corresponding change in the position of the floating ladder.

23. The floating-roof tank assembly according to claim 1, wherein the floating-roof tank assembly comprises a plurality of frequency modulated continuous wave container lidar units configured to monitor the status of the container.

24. The floating-roof tank assembly according to claim 1, wherein the controller is configured to correlate multiple fiber optic sensors to determine the orientation of the impermeable roof section.

25. The floating-roof tank assembly according to claim 1, wherein the one or more fiber optic sensors comprises a tilt sensor mounted on a tilting structure connected between the container and the roof and configured to tilt as the height of the roof changes, and wherein the controller is configured to determine the height of the roof based on the tilt of the tilting structure.

26. (canceled)

27. (canceled)

28. (canceled)

29. (canceled)

30. A floating-roof tank assembly comprising:
a floating roof having:
an impermeable roof section;
a floating-roof seal configured to span between the impermeable roof section and one or more walls of a container;
one or more floats attached to the roof section;
a sensor assembly comprising:
a plurality of lidar units, each lidar unit comprising:
a lidar optic sensor array configured to emit light towards a top of the floating roof;
a lidar receiver configured to detect light reflected off the top of the floating roof; and
a controller configured to process the light received by the lidar receiver to determine the status of the floating roof tank.

31. The floating-roof tank assembly of claim 30, wherein the lidar units are configured to determine one or more of: a position of the roof section; an orientation of the roof section; a velocity of the roof section; a frequency of vibration of the roof section.

32. (canceled)

33. (canceled)

34. The use according to claim 30, wherein the one or more monitored surfaces comprise a top surface of the floating roof.

35. (canceled)
